(19) United States
(12) Patent Application Publication
(10) Pub. No.: US 2022/0304513 A1
(43) Pub. Date: Sep. 29, 2022

(54) MULTIPURPOSE FOOD PROCESSOR

(71) Applicant: HPC Brands, LLC, Middleton, WI (US)

(72) Inventors: James MITRIK, Fairfield, NJ (US); Paul MCGRATH, Fairfield, NJ (US); Alejandro G. LOZANO, Fairfield, NJ (US)

(73) Assignee: HPC Brands, LLC, Middleton, WI (US)

(21) Appl. No.: 17/209,799

(22) Filed: Mar. 23, 2021

(51) Int. Cl. A47J 43/06; A47J 19/02; A23P 30/20; A21C 11/16; A22C 17/00

(52) U.S. Cl. CPC A47J 43/06; A47J 19/025; A23P 30/20; A21C 11/16; A22C 17/0026

(57) ABSTRACT

The present technology provides a device, such as a food processor with interchangeable components to allow the device to serve as a juicer, pasta maker, slicer, grinder, and frozen dessert maker. The device driver receives components that attach to the outlet of the device driver via a screwed connection or other suitable connection. The device drives a central shaft connected to interchangeable components that mix pasta ingredients, drive an extrusion auger, drive a rotating slicer, or perform any other suitable functions. The components may extrude pasta, juiced pulp, frozen desserts, or ground meat. The components may receive food products and auger the food products via a tube or cylinder via a helical screwed surface of the auger. Other components drive a food slicer or a meat grinder. By changing the components connected to the drive motor of the device, five different food processing functions may be utilized.

### FIELD OF INVENTION

The present invention relates to food processing devices. In greater particularity, the present invention relates to a single food processing device with interchangeable components to allow the device to serve as a juicer, pasta maker, slicer, grinder, and frozen dessert maker.

### BACKGROUND

Conventional food processors typically are configured to perform a single type of processing to a food item. For example, certain processors use various mechanical devices to grind or mix food items. Conventional food processors perform a limited number of tasks to process food. Certain conventional food processors are able to extrude food items, while others are able to grind foods.

### SUMMARY OF THE INVENTION

The present technology provides a device, such as a food processor with interchangeable components to allow the device to serve as a juicer, pasta maker, slicer, grinder, and frozen dessert maker. The device driver is configured to receive components for each of these purposes, such as components that attach to the outlet of the device driver via a screwed connection or other suitable locking connection. In an example, the device includes an electrically-powered motor that drives a central shaft or connects to central shafts particular to one or more interchangeable components. The shaft may be connected to components that mix pasta ingredients, drive an extrusion auger, drive a rotating slicer, or perform any other suitable functions. One or more interchangeable components include an extrusion auger that drives any suitable component to mix and extrude pasta, juice pulp, extrude frozen desserts, grind and extrude meat, or perform any other suitable food processing. The rotating extrusion auger may receive food products and force the food products via a tube or cylinder from a base of the auger along the length of the auger via a helical screwed surface of the auger. The auger serves to force foods through an extrusion port, grind food, or compress food. Another interchangeable component turns a bladed cylinder to slice food products. By changing the components connected to the drive motor of the device, five different food processing functions may be utilized.

The present technology provides a method of using the food processor with interchangeable components as a juicer, pasta maker, slicer, grinder, and frozen dessert maker. A user selects one of the components to achieve the desired function, installs the component, initiates the device with the control panel, and adds the food item to be processed.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

The drawings are appended hereto and form a portion of this disclosure.

FIG. 1 is a perspective view of one embodiment of a food processing device absent any interchangeable components, in accordance with certain examples of the technology disclosed herein.

FIG. 2 is a side view of one embodiment of the food processing device absent any interchangeable components, in accordance with certain examples of the technology disclosed herein.

FIG. 3 is a top view of the food processing device absent any interchangeable components, in accordance with certain examples of the technology disclosed herein.

FIG. 4 is a perspective view of one embodiment of the food processing device with a frozen dessert component attached, in accordance with certain examples of the technology disclosed herein.

FIG. 5 is an exploded perspective view of internal components of the frozen dessert component, in accordance with certain examples of the technology disclosed herein.

FIG. 6 is a side view of the food processing device with the frozen dessert component attached, in accordance with certain examples of the technology disclosed herein.

FIG. 7 is a top view of the food processing device with the frozen dessert component attached, in accordance with certain examples of the technology disclosed herein.

FIG. 8 is a perspective view of the frozen dessert component, in accordance with certain examples of the technology disclosed herein.

FIG. 9 is a side view of the frozen dessert component, in accordance with certain examples of the technology disclosed herein.

FIG. 10 is a top view of the frozen dessert component, in accordance with certain examples of the technology disclosed herein.

FIG. 11 is a perspective view of one embodiment of the food processing device with a juicer component attached, in accordance with certain examples of the technology disclosed herein.

FIG. 12 is an exploded perspective view of internal components of the juicer component, in accordance with certain examples of the technology disclosed herein.

FIG. 13 is a side view of the food processing device with the juicer component attached, in accordance with certain examples of the technology disclosed herein.

FIG. 14 is a top view of the food processing device with the juicer component attached, in accordance with certain examples of the technology disclosed herein.

FIG. 15 is a perspective view of the juicer component, in accordance with certain examples of the technology disclosed herein.

FIG. 16 is a side view of the juicer component, in accordance with certain examples of the technology disclosed herein.

FIG. 17 is a top view of the juicer component, in accordance with certain examples of the technology disclosed herein.

FIG. 18 is a perspective view of one embodiment of the food processing device with a grinder component attached, in accordance with certain examples of the technology disclosed herein.

FIG. 19 is an exploded perspective view of internal components of the grinder component, in accordance with certain examples of the technology disclosed herein.

FIG. 20 is a side view of the food processing device with the grinder component attached, in accordance with certain examples of the technology disclosed herein.

FIG. 21 is a top view of the food processing device with the grinder component attached, in accordance with certain examples of the technology disclosed herein.

FIG. 22 is a perspective view of the grinder component, in accordance with certain examples of the technology disclosed herein.

FIG. 23 is a side view of the grinder component, in accordance with certain examples of the technology disclosed herein.

FIG. 24 is a top view of the grinder component, in accordance with certain examples of the technology disclosed herein.

FIG. 25 is a perspective view of one embodiment of the food processing device with a pasta maker component attached, in accordance with certain examples of the technology disclosed herein.

FIG. 26 is an exploded perspective view of internal components of the pasta maker component, in accordance with certain examples of the technology disclosed herein.

FIG. 27 is a side view of the food processing device with the pasta maker component attached, in accordance with certain examples of the technology disclosed herein.

FIG. 28 is a top view of the food processing device with the pasta maker component attached, in accordance with certain examples of the technology disclosed herein.

FIG. 29 is a perspective view of the pasta maker component, in accordance with certain examples of the technology disclosed herein.

FIG. 30 is a side view of the pasta maker component, in accordance with certain examples of the technology disclosed herein.

FIG. 31 is a top view of the pasta maker component, in accordance with certain examples of the technology disclosed herein.

FIG. 32 is a perspective view of one embodiment of the food processing device with a slicer component attached, in accordance with certain examples of the technology disclosed herein.

FIG. 33 is an exploded perspective view of internal components of the slicer component, in accordance with certain examples of the technology disclosed herein.

FIG. 34 is a side view of the food processing device with the slicer component attached, in accordance with certain examples of the technology disclosed herein.

FIG. 35 is a top view of the food processing device with the slicer component attached, in accordance with certain examples of the technology disclosed herein.

FIG. 36 is a perspective view of the slicer component, in accordance with certain examples of the technology disclosed herein.

FIG. 37 is a side view of the slicer component, in accordance with certain examples of the technology disclosed herein.

FIG. 38 is a top view of the slicer component, in accordance with certain examples of the technology disclosed herein.

### DETAILED DESCRIPTION

The examples described herein provide a food processor with interchangeable components to allow the device to serve as a juicer, pasta maker, slicer, grinder, and frozen dessert maker. The examples describe the interchangeability of the components that allow the multiple food processing methods to be performed on the single device. A single drive motor drives components that attach to the outlet of the device driver via a screwed connection or other suitable locking connection. In an example, the device includes an electrically-powered motor that drives a central shaft. The shaft may be connected to components that mix pasta ingredients, drive an extrusion auger, drive a rotating slicer, or perform any other suitable functions. The extrusion auger drives any suitable component to extrude pasta, juiced pulp, frozen desserts, ground meat, or perform any other suitable food processing technique.

Existing food processing devices do not allow components to be changed to allow the single device to serve as a juicer, pasta maker, slicer, grinder, and frozen dessert maker. The drive motor of the device causes one changeable component to mix and extrude pasta, the same or a similar component to extrude frozen desserts, the same or a similar component to juice fruits and vegetables while extruding the pulp. The same drive is connected to a component to grind meat or other similar foods. The same drive is connected to a component to slice meat or other similar foods.

Existing food processing technologies require a separate device to perform each of these tasks. By using the same drive mechanism to drive a central shaft in each of the disparate components, the single device can perform each of these seemingly unrelated tasks. The interchangeable drive components of the present technology allow for a combination of processes that are not obvious over conventional food processors.

The components may be connectable to the drive in any suitable manner. For example, a component with a mixing chamber and an extrusion nozzle to make pasta is connected to the drive via a screwed connection, a snap connection, a bolted connection, a latched connection, or any other suitable connection. The mixing chamber and extrusion nozzle are affixed to the body of the device such that the mixing chamber is enclosed and food products are contained inside the mixing chamber. The mixing paddles, auger, and the extrusion nozzle are affixed to, and mated to, the drive such that when the drive turns, the components are turned. The product is augured out of the mixing chamber and through the extrusion nozzle.

In another example, a component with a juicing chamber and extrusion nozzle to juice fruits and vegetables is connected to the drive via a screwed connection, a snap connection, a bolted connection, a latched connection, or any other suitable connection. The juicing chamber and extrusion nozzle are affixed to the body of the device such that the juicing chamber drains expelled juice into a collection bin. The augur and the extrusion nozzle are affixed to, and mated to, the drive such that when the drive turns, the auger is turned and compresses the food products against a filter. The juice drains through the filter and downward into the collection bin, and the remaining food pulp is augured out of the juicing chamber and through the extrusion nozzle.

In another example, a component with an extrusion nozzle to extrude frozen food components, such as frozen fruits and vegetables, is connected to the drive via a screwed connection, a snap connection, a bolted connection, a latched connection, or any other suitable connection. The auger and extrusion nozzle are affixed to the body of the device such that the frozen desserts are compressed and extruded into a collection bin. The augur and the extrusion nozzle are affixed to, and mated to, the drive such that when the drive turns, the auger is turned and compresses the food products against the extrusion nozzle. The extruded frozen desserts extrude downward into the collection bin.

In another example, a component with a food grinder to grind meat or other food products is connected to the drive via a screwed connection, a snap connection, a bolted connection, a latched connection, or any other suitable connection. The food grinder is affixed to the body of the device such that solid food is ground into smaller components and dispelled into a collection bin. The food grinder is affixed to, and mated to, the drive such that when the drive turns, the food grinder auger is turned and compresses the food products against a grinder blade. The ground food is forced by the auger through an extrusion plate and falls downward into the collection bin.

In another example, a component with a food slicer to slice meat or other food products is connected to the drive via a screwed connection, a snap connection, a bolted connection, a latched connection, or any other suitable connection. The food slicer is affixed to the body of the device such that solid food is sliced into smaller components and dispelled into a collection bin. The food slicer is affixed to, and mated to, the drive such that when the drive turns, the food slicer turns. The food is forced by a plunger against the food slicer through a chute. The sliced food falls downward into the collection bin.

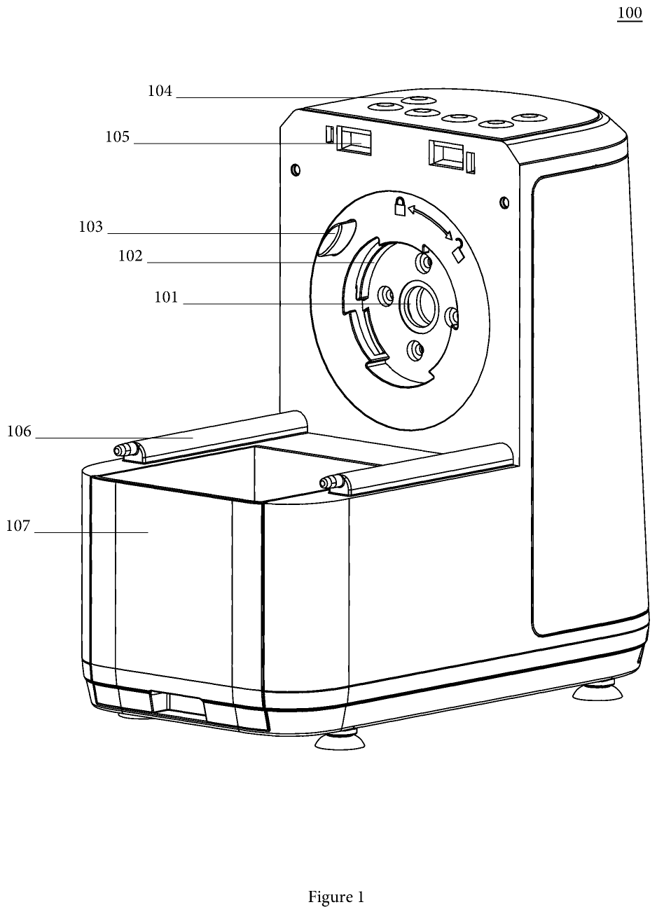

FIG. 1 is a perspective view of one embodiment of a food processing device 100 absent any interchangeable components, in accordance with certain examples of the technology disclosed herein. This base unit of the device 100 receives components to process foods. The device 100 is illustrated with a control panel 104 on top of a body of the device 100. The control panel 104 may include controls for functions such as a power button, a time display, a start/pause button, a button to reverse the direction of the drive, a mixing button, a batch button to initiate a preset batch function. The buttons may be depressible switches, virtual buttons, toggles, touchscreen buttons, or any other suitable control panel interface objects.

The batch button is configured to initiate a preset batch function, such as to mix and extrude a configured amount of pasta. In an example, the single button when actuated causes the device 100 with a pasta maker component 2200 to operate the drive shaft socket 101 automatically such that the pasta maker component 2200 performs the actions required to make a batch of pasta without any further actions from the user to operate the device 100. That is, the process is automatic in that the user is not required to press buttons or perform any other actions to cause the device 100 to turn, pause, change directions, extrude pasta, or stop operating.

In the example, a user places the ingredients for a pasta batch into the mixing chamber 2202 of the pasta maker component 2200 and presses the batch button. In the example, a user actuates the batch button one time for a single batch, such as a half of a pound of pasta, and twice for a double batch, such as one pound of pasta. The device 100 begins to turn the paddles 2313 and the auger 2311 of the pasta maker component 2200 in a counter-clockwise direction. The turning paddles 2313 mix and knead the pasta. The auger 2311 does not force the pasta through the extrusion cap 2204 because the helical blades of the auger 2311 are configured to operate in the clockwise direction. The pasta continues to mix until the pasta is completely mixed and kneaded. The device 100 may determine that the pasta is completely mixed based on a preset time duration of mixing. Alternatively, the sensor may determine that the pasta is mixed based on a sensor, such as a sensor that measures an amount of force required to turn the paddles 2313. Any other criteria may be used to determine that the pasta is mixed.

The device 100 automatically pauses and reverses the direction of the drive shaft socket 101. The device 100 begins to turn the paddles 2313 and the auger 2311 of the pasta maker component 2200 in a clockwise direction. The clockwise turning of the auger 2311 forces the pasta out of the extrusion cap 2204. Periodically, the device 100 will reverse the direction of the drive shaft socket 101 to mix the pasta further. After mixing, the device 100 will reverse the direction of the drive shaft socket 101 to again extrude the pasta. These periodic mixing cycles may occur any suitable number of times in the process, such as one, two, three, or four times. When the pasta is completely extruded, the device 100 stops the turning of the drive shaft socket 101.

Other batch button may be used to automatically perform the operations of any of the other functions of the device 100. For example, a batch button may be used to operate an automatic process to use the juicer, the frozen dessert maker, the grinder, or the slicer.

The device 100 is illustrated with a collection bin 107 for receiving food. Different component configurations may use different types of collection bins 107. Fastening mechanisms 106 are located on either side of the collection bin 107 for securing one or more components to the base of the device 100. For example, a pasta maker component may have grooves on a mixing chamber that mates with the fastening mechanism 106 to hold the chamber in place. The mixing chamber slots 105 similarly allow the device 100 to secure one or more components to the body of the device 100. For example, a pasta maker mixing chamber may have clips or other protrusions that mate with the slots 105 to secure the mixing chamber to the device 100.

The mounting ring 102 attaches the various components to the device 100. Each component may be screwed into the mounting ring 102 with a mating screwed connection on each respective component. For example, a component, such as the juicer component or the grinder component, may have a screwed connection that matches the shape of the mounting ring 102 such that the component slides inside the mounting ring 102 and may be screwed to fasten the mounting ring 102 to the component. Any type of suitable connection may be utilized for the mounting ring 102, such as screwed connection, a friction connection, a bolt-on connection, a latched connection, or any other suitable connection. The release button 103 is illustrated as a physical, tactile button that forces the mounting ring 102 to release the screwed or locked connection between the mounting ring 102 and the screwed component.

When the component is connected to the mounting ring 102, a drive shaft on the component is inserted into the drive shaft socket 101. The drive shaft socket 101 is affixed to the drive motor in the device 100 such that when the drive motor is engaged, the drive motor spins the drive shaft socket 101. The drive shaft socket 101 is constructed with sides forming a polygon shape, such as a hexagon or a pentagon. That is the drive shaft connector 101 has flat surfaces displaced around the inner surface to engage a drive shaft. The drive shaft, such as the drive shaft on any of the various components has flat surfaces along the outer perimeter of the drive shaft to mate with the drive shaft socket 101. When the drive shaft socket 101 turns, the drive shaft is forced to similarly turn.

The connecting pieces of the device 100, such as the drive shaft socket 101, the mounting ring 102, the fastening mechanism 106, or other suitable features, allow a user to affix any of five or more components to the device 100, such as components for a juicer, pasta maker, slicer, grinder, and frozen dessert maker. Existing food processing devices do not have connecting pieces or a universal design that allows these components to be interchanged on a single device.

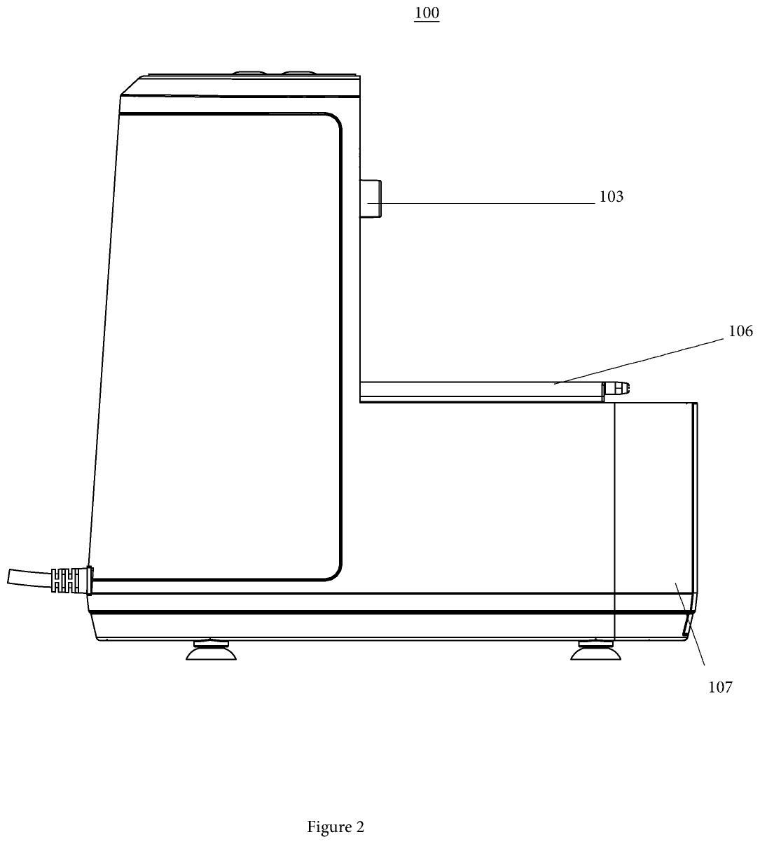

FIG. 2 is a side view of one embodiment of the food processing device 100 absent any interchangeable components, in accordance with certain examples of the technology disclosed herein. Illustrated in FIG. 2 are the body of the device 100, the collection bin 107, the fastening mechanism 106, and the release button 103. Any of the various components may be mounted onto the body of the device 100 from the front of the device 100 as described herein.

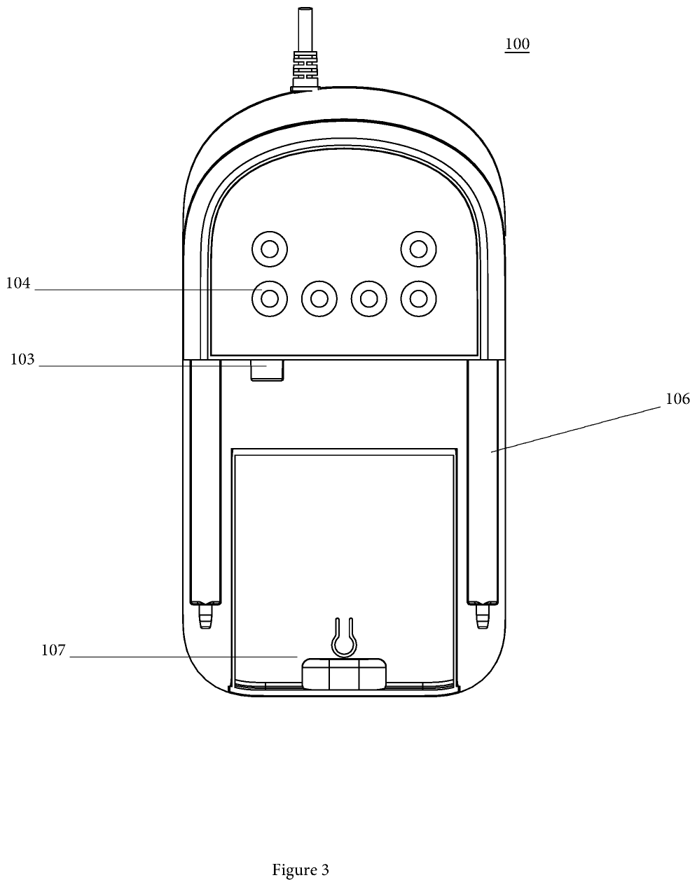

FIG. 3 is a top view of the food processing device 100 absent any interchangeable components, in accordance with certain examples of the technology disclosed herein. Illustrated in FIG. 3 are the body of the device 100, the control panel 104, the collection bin 107, the fastening mechanism 106, and the release button 103. Any of the various components may be mounted onto the body of the device 100 from the front of the device 100 as described herein.

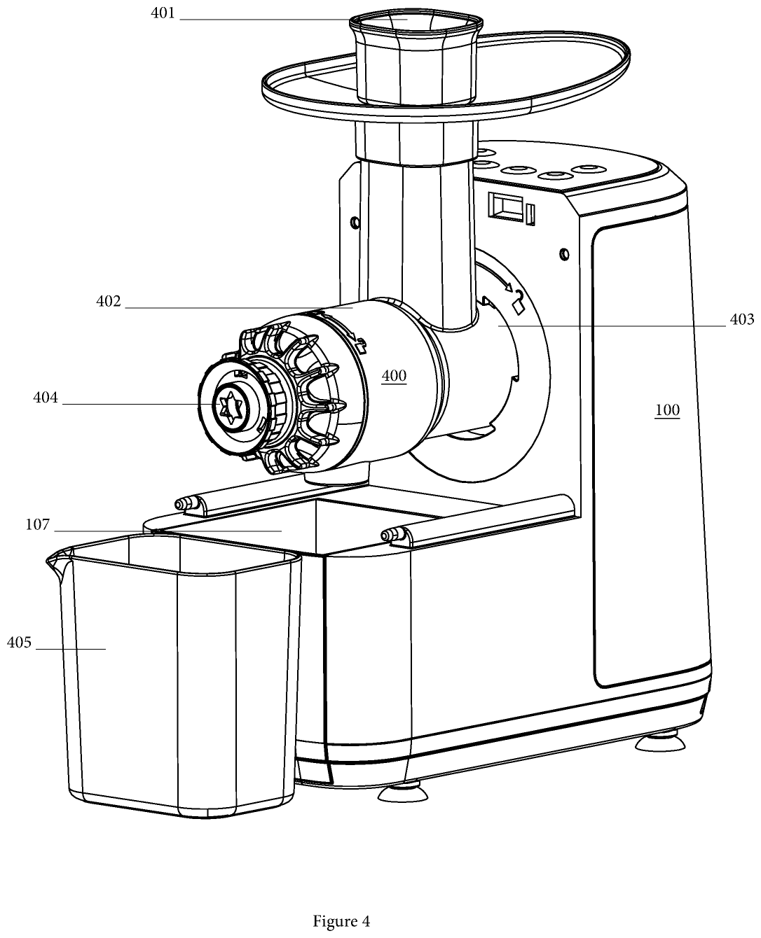

FIG. 4 is a perspective view of one embodiment of the food processing device 100 with a frozen dessert component 400 attached, in accordance with certain examples of the technology disclosed herein. As described herein, the frozen dessert component 400 is connected to the device 100 via the mounting ring 102 and/or other connection mechanisms. A mated screwed connection 403 of the frozen dessert component 400 is screwed or otherwise connected into the mounting ring 102. In the example, the mated screwed connection 403 is inserted into the opening of the mounting ring 102 and rotated counter-clockwise to lock the frozen dessert component 400 onto the device 100. The connection may be a screwed connection, a friction connection, a bolt-on connection, a latched connection, or any other suitable connection.

The frozen dessert component 400 is illustrated with a chute 401 for delivering food items to the body of the frozen dessert component 400. In an example, a plunger or other device is used to push food items, such as frozen fruits, vegetables, or other suitable frozen foods, down to the auger. The frozen dessert component 400 is shown with a star-shaped extrusion cap 404. Other shapes of extrusion cap 404 may be used, such as round, square, or hexagonal. The cap is screwed or otherwise affixed to the body of the frozen dessert component 400, such as by a seal cap connected to the unit housing 402. The unit housing 402 encases the auger and other components used to compress and extrude a frozen dessert.

In an example, the drive shaft connected to the auger forces the auger to spin. The frozen fruit or other food items are forced into the chute 401 by a plunger or other device. The auger grabs the frozen fruit with the helical teeth of the auger and forces the frozen fruit downstream within the unit housing 402, such as by a screwed effect. The frozen fruit is mixed and forced into a smaller cross-sectional space to compress the frozen fruit. The auger continues to increase the pressure of the frozen fruit until the frozen fruit is extruded through the extrusion cap 404. The extruded frozen fruit is either collected by a user or falls into the collection bin 405, which is affixed to or adjacent to the collection bin 107.

After the frozen fruit has all been extruded, the frozen dessert component 400 may be removed from the device 100 by pushing the release button 103, unscrewing the mated screwed connection 403 from the mounting ring 102, or in any other suitable manner disengaging the frozen dessert component 400.

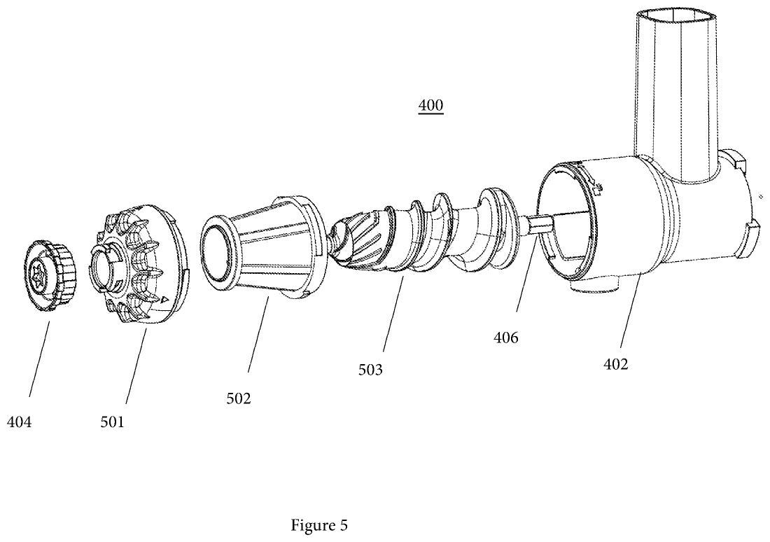

FIG. 5 is an exploded perspective view of internal components of the frozen dessert component 400, in accordance with certain examples of the technology disclosed herein. The unit housing 402 is illustrated with the auger 503 and other components removed. When in operation, one or more of the components in the exploded diagram are connected or encased in another component. For example, the auger 503 is inside the inner chamber of the unit housing 402 when in operation. The drive shaft 406 is integral to or connected to the auger 503. The drive shaft 406 is illustrated with a hexagonal outer perimeter for mounting into the drive shaft socket 101.

The auger 503 is illustrated with a helical screw on the body that when screwed in a clockwise direction, forces food items toward the tip of the auger 503 and away from the drive shaft 406. Any other configuration of auger 503 may be used to force the food downstream, such as a piston type device or a baffled auger. The blocker 502, or blocking screen 502, is optionally installed over the tip of the auger 503. The blocker 502 forces the frozen food items towards the extrusion cap 404. The blocker 502 includes internal grooves to grind and mix the food items as they are forced along the length of the blocker 502. The blocker 502 prevents any liquid juices from being separated from the pulp of the frozen foods as the foods are ground. The juice and pulp are mixed together and expelled from the extrusion cap 404 concurrently. This process provides for a smoother frozen dessert consistency compared to the crumbly pulp that is created when juicing.

The seal cap 501 is affixed to the unit housing 402 via a screwed mechanism, a friction mechanism, latches, a bolted mechanism, or any other suitable connection mechanism. The extrusion cap 404 is similarly affixed to the seal cap 501. All of the components illustrated may be connected into a single unit to form the frozen dessert component 400.

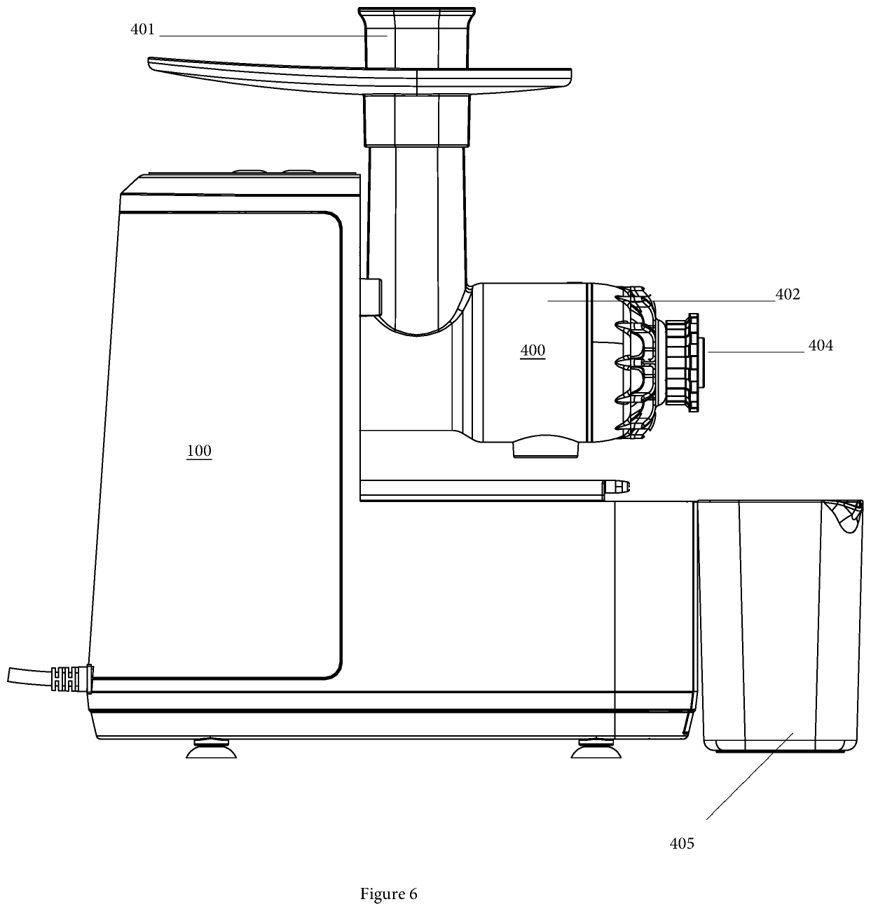

FIG. 6 is a side view of the food processing device 100 with the frozen dessert component 400 attached, in accordance with certain examples of the technology disclosed herein. Illustrated in FIG. 6 are the body of the device 100, the frozen dessert component 400, the collection bin 405, the unit housing 402, the chute 401, and the extrusion cap 404. In the example, the frozen foods are forced down the chute 401 into the unit housing 402, where the auger 503 forces the frozen foods out of the extrusion cap 404.

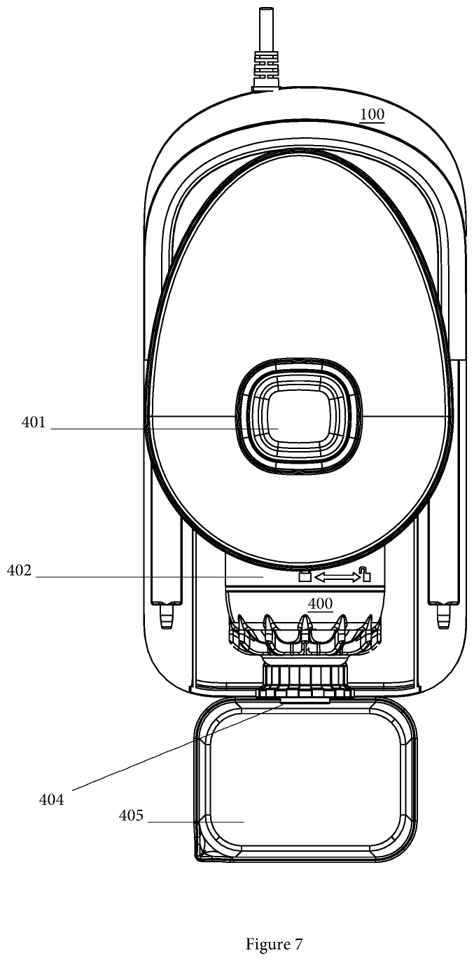

FIG. 7 is a top view of the food processing device 100 with the frozen dessert component 400 attached, in accordance with certain examples of the technology disclosed herein. Illustrated in FIG. 7 are the body of the device 100, the frozen dessert component 400, the collection bin 405, the unit housing 402, the chute 401, and the extrusion cap 404. In the example, the frozen foods are forced down the chute 401 into the unit housing 402, where the auger 503 forces the frozen foods out of the extrusion cap 404.

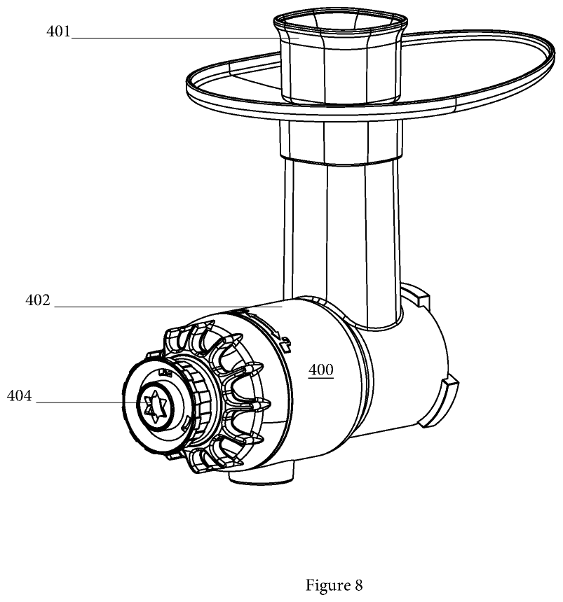

FIG. 8 is a perspective view of the frozen dessert component 400, in accordance with certain examples of the technology disclosed herein. Illustrated in FIG. 8 are the frozen dessert component 400, the collection bin 405, the unit housing 402, the chute 401, and the extrusion cap 404. In the example, the frozen foods are forced down the chute 401 into the unit housing 402, where the auger 503 forces the frozen foods out of the extrusion cap 404.

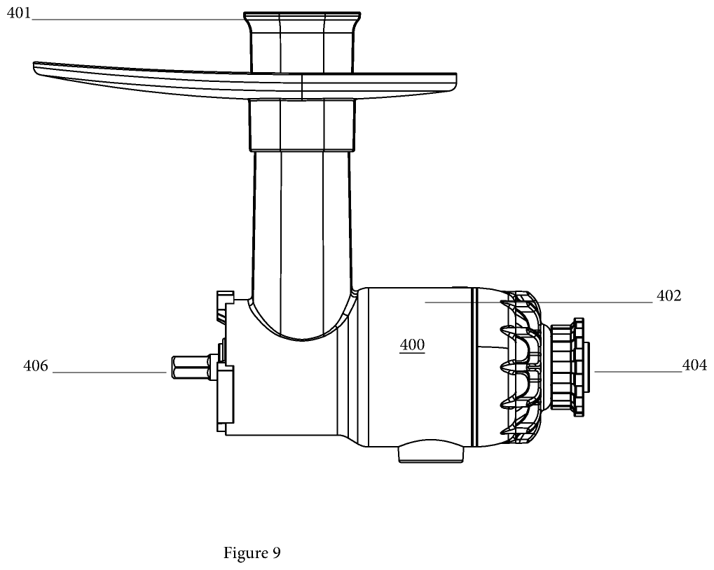

FIG. 9 is a side view of the frozen dessert component 400, in accordance with certain examples of the technology disclosed herein. Illustrated in FIG. 9 are the frozen dessert component 400, the collection bin 405, the unit housing 402, the chute 401, the drive shaft 406, and the extrusion cap 404. In the example, the frozen foods are forced down the chute 401 into the unit housing 402, where the auger 503 forces the frozen foods out of the extrusion cap 404. The drive shaft 406 is connected to the auger 503, inserts into the drive shaft socket 101 of the device 100, and forces the auger 503 to turn when the drive shaft socket 101 turns.

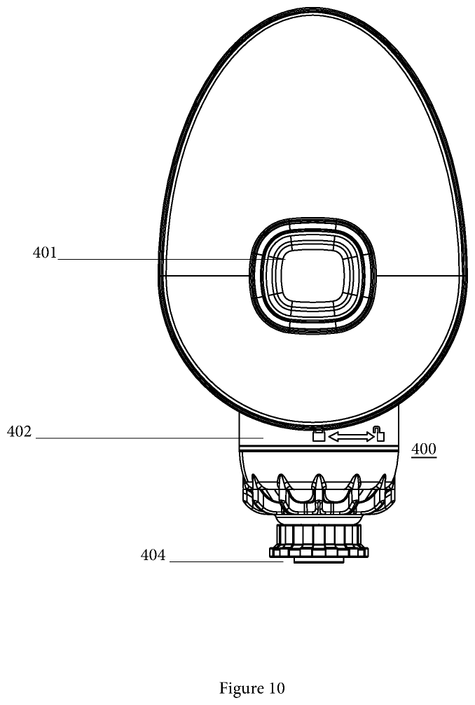

FIG. 10 is a top view of the frozen dessert component 400, in accordance with certain examples of the technology disclosed herein. Illustrated in FIG. 10 are the frozen dessert component 400, the unit housing 402, the chute 401, and the extrusion cap 404. In the example, the frozen foods are forced down the chute 401 into the unit housing 402, where the auger 503 forces the frozen foods out of the extrusion cap 404.

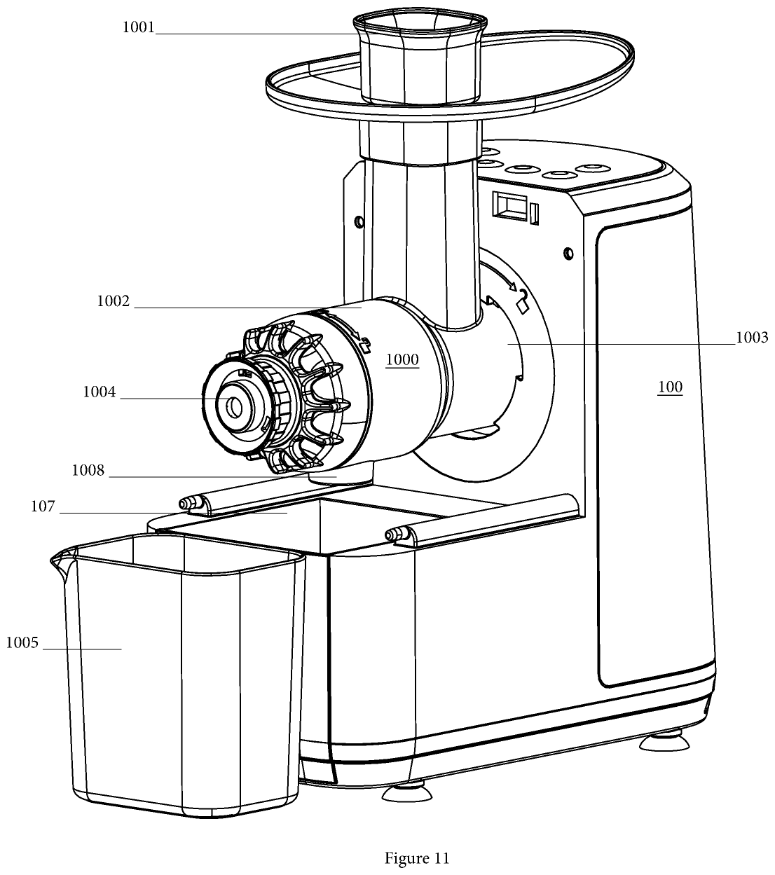

FIG. 11 is a perspective view of one embodiment of the food processing device 100 with a juicer component 1000 attached, in accordance with certain examples of the technology disclosed herein. As described herein, the juicer component 1000 is connected to the device 100 via the mounting ring 102. A mated screwed connection 1003 of the juicer component 1000 is screwed or otherwise connected into the mounting ring 102. In the example, the mated screwed connection 1003 is inserted into the opening of the mounting ring 102 and rotated counter-clockwise to lock the juicer component 1000 onto the device 100. The connection may be a screwed connection, a friction connection, a bolt-on connection, a latched connection, or any other suitable connection.

The juicer component 1000 is illustrated with a chute 1001 for delivering food items to the body of the juicer component 1000. In an example a plunger or other device is used to push food items, such as fruits and vegetables down to the auger. The juicer component 1000 is shown with a round extrusion cap 1004. Other shapes of extrusion cap 1004 may be used, such as square or hexagonal. The cap is screwed or otherwise affixed to the body of the juicer component 1000, such as by a seal cap connected to the unit housing 1002. The unit housing 1002 encases the auger and other components used to extract juice from the food items and extrude the remaining pulp.

In an example, the drive shaft connected to the auger forces the auger to spin. The food items are forced into the chute 1001 by a plunger or other device. The auger grabs the food items with the helical teeth of the auger and forces the food items downstream within the unit housing 1002, such as by a screwed effect. The food items are forced into a smaller cross-sectional space to compress the food items. The compressed food items are pressed against a filter to separate the juice from the pulp under pressure. The filter may include grooves or other rough surfaces to grind the food items. The auger continues to increase the pressure of the food items until the juice passes through the filter and falls through a bottom port 1008 of the of the unit housing 1002 into the collection bin 107. The pulp does not pass through the filter, but is forced out of the opposing end of the filter towards the extrusion cap. The pulp is extruded through the extrusion cap 1004. The extruded pulp is either collected by a user or falls into the collection bin 1005, which is affixed to or adjacent to the collection bin 107.

After the food items have been compressed and juiced, the juicer component 1000 may be removed from the device 100 by pushing the release button 103, unscrewing the mated screwed connection 1003 from the mounting ring 102, or in any other suitable manner disengaging the juicer component 1000.

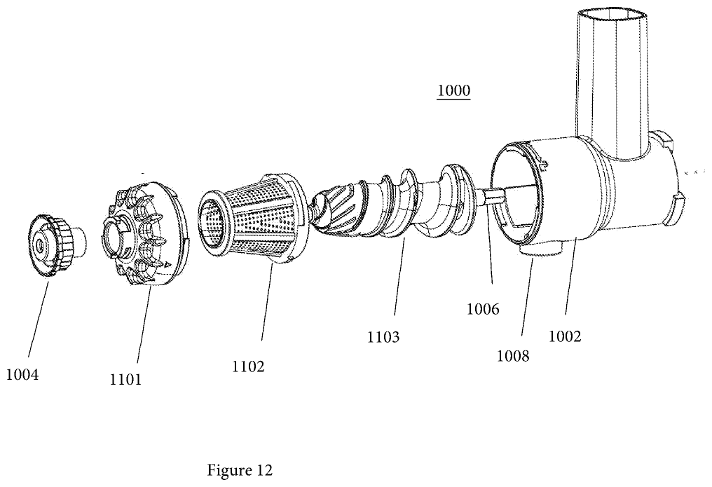

FIG. 12 is an exploded perspective view of internal components of the juicer component 1000, in accordance with certain examples of the technology disclosed herein. The unit housing 1002 is illustrated with the auger 1103 and other components removed. When in operation, one or more of the components in the exploded diagram are connected or encased in another component. For example, the auger 1103 is inside the inner chamber of the unit housing 1002 when in operation. The drive shaft 1006 is integral to or connected to the auger. The drive shaft 1006 is illustrated with a hexagonal outer perimeter for mounting into the drive shaft connector 101.

The auger 1103 is illustrated with a helical screw on the body that when screwed in a clockwise direction, forces food items toward the tip of the auger 1103 and away from the drive shaft 1006. Any other configuration of auger 1103 may be used to force the food downstream, such as a piston type device or a baffled auger. The filter 1102 is optionally installed over the tip of the auger 1103. The filter 1102 separates any liquids in the food items from the solid pulp in the food items. The filter 1102 prevents the pulp from passing through the filter, but allows the juice or other liquids to pass through the filter 1102. The auger 1103 continues to force the pulp towards the extrusion cap 1004 out the opening on the opposing end of the filter 1102. The filter 1102 includes internal grooves to grind the food items as they are forced along the length of the filter 1102. The pulp is expelled from the extrusion cap 1004 while the juice is allowed to drain through the bottom port 1008 of the unit housing 1002.

The seal cap 1101 is affixed to the unit housing 1002 via a screwed mechanism, a friction mechanism, latches, a bolted mechanism, or any other suitable connection mechanism. The round extrusion cap 1004 is similarly affixed to the seal cap 1001. Any other suitable shape of opening on the extrusion cap 1004 may be used. All of the components illustrated may be connected into a single unit to form the juicer component 1000.

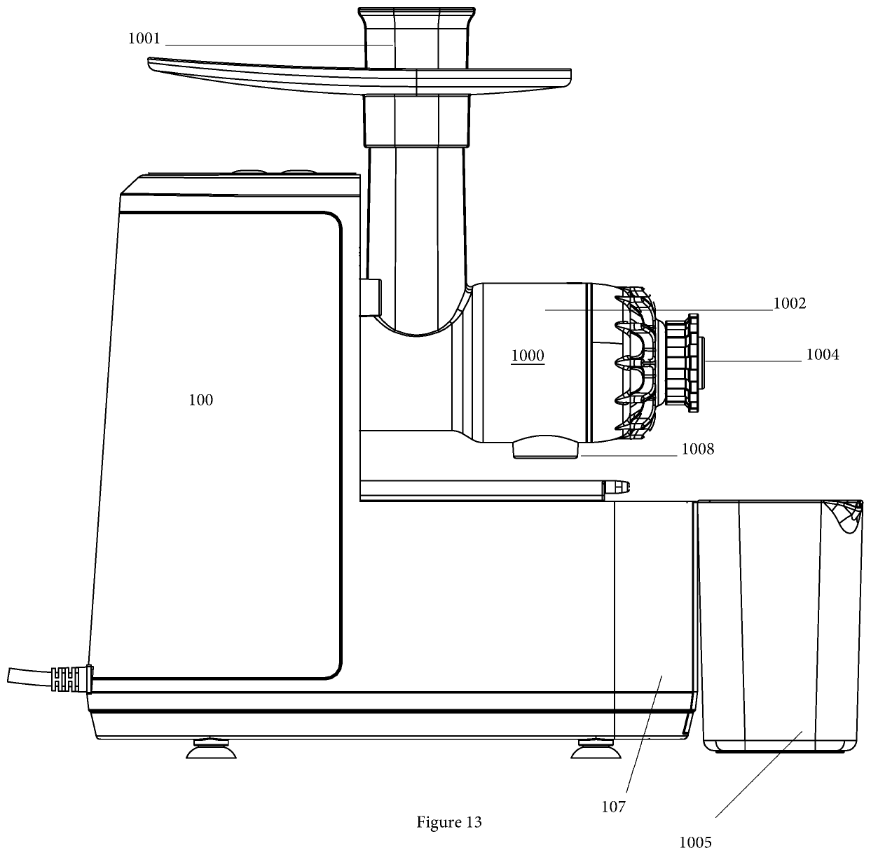

FIG. 13 is a side view of the food processing device 100 with the juicer component 1000 attached, in accordance with certain examples of the technology disclosed herein. Illustrated in FIG. 13 are the body of the device 100, the juicer component 1000, the collection bin 1005, the collection bin 107, the unit housing 1002, the chute 1001, and the extrusion cap 1004. In the example, the foods are forced down the chute 1001 into the unit housing 1002, where the auger 1103 forces the food items through the filter 1102. The juice or other liquid drains through the filter 1102 and through the bottom port 1008 and into the collection bin 107. The pulp is forced though the extrusion cap 1004 into the collection bin 1005.

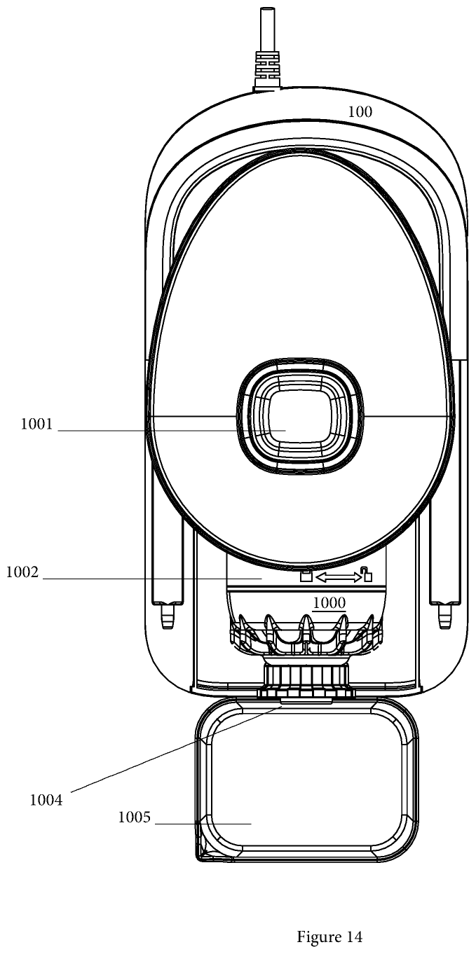

FIG. 14 is a top view of the food processing device 100 with the juicer component 1000 attached, in accordance with certain examples of the technology disclosed herein. Illustrated in FIG. 14 are the body of the device 100, the juicer component 1000, the collection bin 1005, the unit housing 1002, the chute 1001, and the extrusion cap 1004. In the example, the foods are forced down the chute 1001 into the unit housing 1002, where the auger 1103 forces the food items through the filter 1102. The juice or other liquid drains through the filter 1102 and through the bottom port 1008 and into the collection bin 107. The pulp is forced though the extrusion cap 1004 into the collection bin 1005.

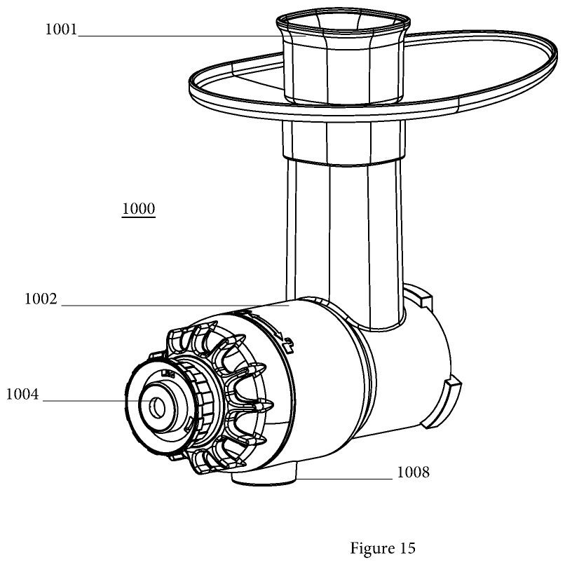

FIG. 15 is a perspective view of the juicer component 1000, in accordance with certain examples of the technology disclosed herein. Illustrated in FIG. 15 are the juicer component 1000, the unit housing 1002, the chute 1001, the bottom port 1008, and the extrusion cap 1004. In the example, the foods are forced down the chute 1001 into the unit housing 1002, where the auger 1103 forces the food items through the filter 1102. The juice or other liquid drains through the filter 1102 and through the bottom port 1008. The pulp is forced though the extrusion cap 1004.

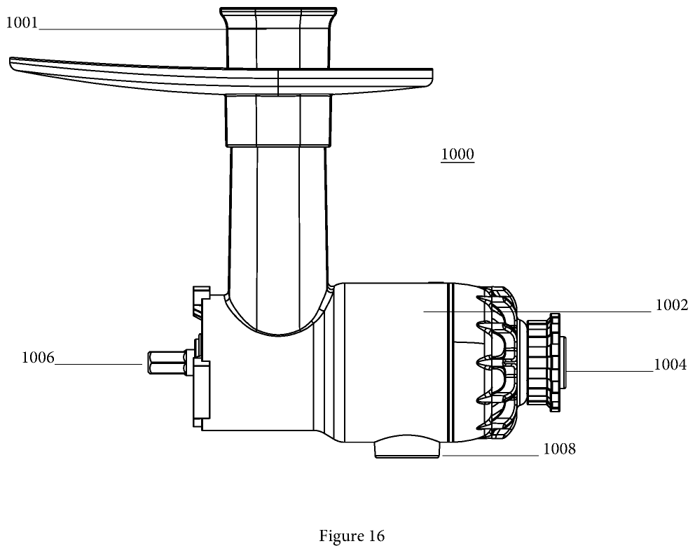

FIG. 16 is a side view of the juicer component 1000, in accordance with certain examples of the technology disclosed herein. Illustrated in FIG. 16 are the juicer component 1000, the unit housing 1002, the chute 1001, the bottom port 1008, the drive shaft 1006, and the extrusion cap 1004. In the example, the foods are forced down the chute 1001 into the unit housing 1002, where the auger 1103 forces the food items through the filter 1102. The drive shaft 1006 is connected to the auger 1103, inserts into the drive shaft socket 101 of the device 100, and forces the auger 1103 to turn when the drive shaft socket 101 turns. The juice or other liquid drains through the filter 1102 and through the bottom port 1008. The pulp is forced though the extrusion cap 1004.

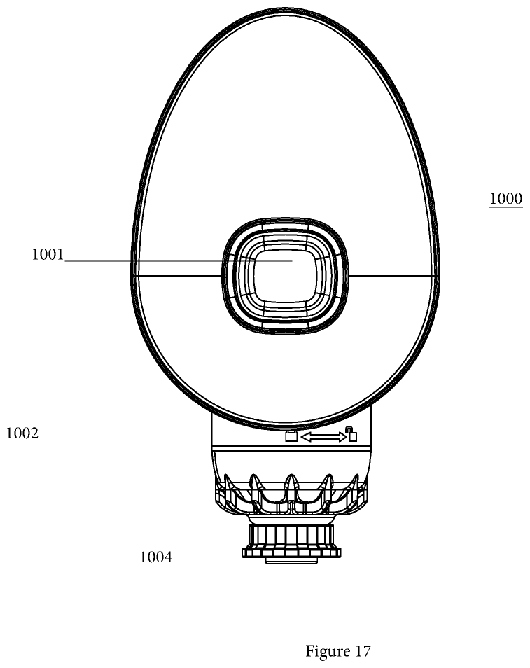

FIG. 17 is a top view of the juicer component 1000, in accordance with certain examples of the technology disclosed herein. Illustrated in FIG. 17 are the juicer component 1000, the unit housing 1002, the chute 1001, and the extrusion cap 1004. In the example, the foods are forced down the chute 1001 into the unit housing 1002, where the auger 1103 forces the food items through the filter 1102. The juice or other liquid drains through the filter 1102 and through the bottom port 1008. The pulp is forced though the extrusion cap 1004.

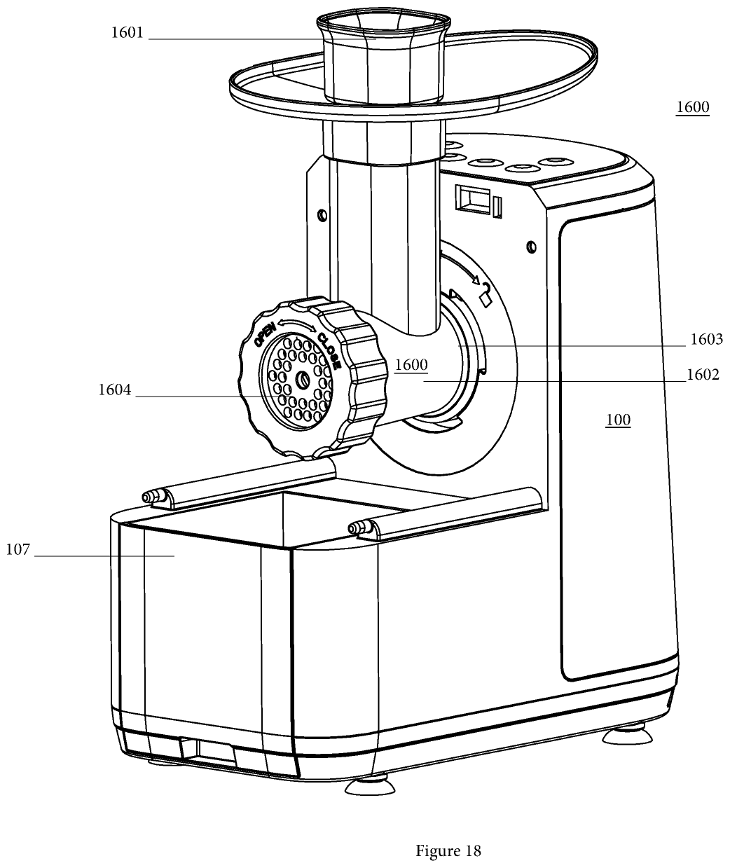

FIG. 18 is a perspective view of one embodiment of the food processing device 1000 with a grinder component 1600 attached, in accordance with certain examples of the technology disclosed herein. As described herein, the grinder component 1600 is connected to the device 100 via the mounting ring 102. A mated screwed connection 1603 of the grinder component 1600 is screwed or otherwise connected into the mounting ring 102. In the example, the mated screwed connection 1603 is inserted into the opening of the mounting ring 102 and rotated counter-clockwise to lock the grinder component 1600 onto the device 100. The connection may be a screwed connection, a friction connection, a bolt-on connection, a latched connection, or any other suitable connection.

The grinder component 1600 is illustrated with a chute 1601 for delivering food items to the body of the grinder component 1600. In an example a plunger or other device is used to push food items, such as meats, cheeses, vegetables, or other suitable foods, down to the auger. The grinder component 1600 is shown with a multi-hole extrusion cap 1604. Other shapes and sizes of the holes of the extrusion cap 1604 may be used, such as square holes, smaller holes, or larger holes. The cap is screwed or otherwise affixed to the body of the grinder component 1600, such as by a seal cap connected to the unit housing 1602. The unit housing 1602 encases the auger and other components used to grind food items.

In an example, the drive shaft connected to the auger forces the auger to spin. The food item is forced into the chute 1601 by a plunger or other device. The auger grabs the food item with the helical teeth of the auger and forces the food item downstream within the unit housing 1602, such as by a screwed effect. The inside perimeter of the unit housing 1602 has blades, grooves, sharpened baffles, or other mechanical means of providing a grinding action to the food items as the auger 1602 moves the food items downstream. In an example, the unit housing blades are configured to be in a helical pattern. In the example, the unit housing blades are helical in a direction counter to the helical direction of the auger 1602 such that the food items are ground between the conflicting edges. The food item is forced against a spinning grinder blade to grind the food item. The auger continues to increase the pressure of the food item until the food item is extruded through the extrusion cap 1604. The extruded food item is either collected by a user or falls into the collection bin 107.

After the food item has all been extruded, the grinder component 1600 may be removed from the device 100 by pushing the release button 103, unscrewing the mated screwed connection 1603 from the mounting ring 102, or in any other suitable manner disengaging the grinder component 1600.

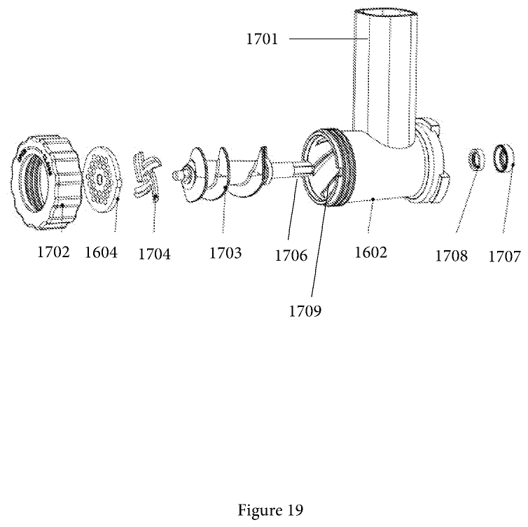

FIG. 19 is an exploded perspective view of internal components of the grinder component 1600, in accordance with certain examples of the technology disclosed herein. The unit housing 1602 is illustrated with the auger 1703 and other components removed. When in operation, one or more of the components in the exploded diagram are connected or encased in another component. For example, the auger 1703 is inside the inner chamber of the unit housing 1602 when in operation. The drive shaft 1706 is integral to or connected to the auger 1703. The drive shaft 1706 is illustrated with a hexagonal outer perimeter for mounting into the drive shaft socket 101.

The auger 1703 is illustrated with a helical screw on the body that when screwed in a clockwise direction, forces food items toward the tip of the auger 1703 and away from the drive shaft 1706. Any other configuration of auger 1703 may be used to force the food downstream, such as a piston type device or a baffled auger. The inside perimeter of the unit housing 1602 has blades 1709, grooves, sharpened baffles, or other mechanical means of providing a grinding action to the food items as the auger 1602 moves the food items downstream. In an example, the blades 1709 are configured to be in a helical pattern. In the example, the blades 1709 are helical in a direction counter to the helical direction of the auger 1703 such that the food items are ground between the conflicting edges. The grinder blade 1704 is installed over the tip of the auger 1703. For example, the grinder blade 1704 may have a socket to fit over a tip of the auger 1703 such that, when the auger 1703 turns, the grinder blade 1704 is forced to turn. The grinder blade 1704 cuts and grinds the food items as the food items pass through from the auger 1703 to the extrusion cap 1604. The ground food items are forced via pressure from the auger 1703 through the holes in the extrusion cap 1604.

The seal cap 1702 is affixed to the unit housing 1602 via a screwed mechanism, a friction mechanism, latches, a bolted mechanism, or any other suitable connection mechanism. The extrusion cap 1604 is similarly affixed to the seal cap 1702. The sealing ring 1708 and the back cover ring 1707 assist in affixing the grinder component 1600 to the device 100.

All of the components illustrated may be connected into a single unit to form the grinder component 1600.

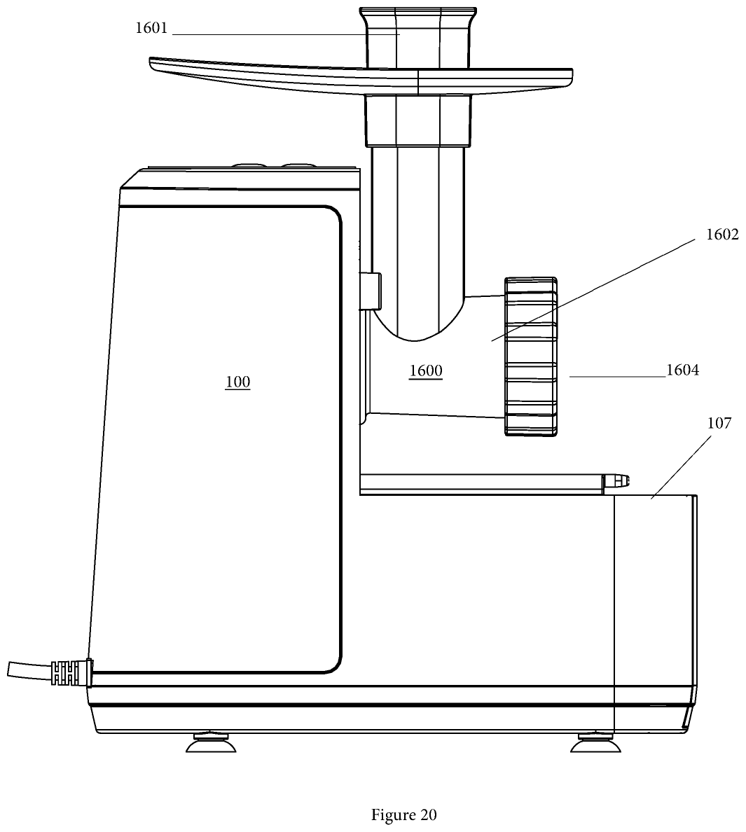

FIG. 20 is a side view of the food processing device 100 with the grinder component 1600 attached, in accordance with certain examples of the technology disclosed herein. Illustrated in FIG. 20 are the body of the device 100, the grinder component 1600, the unit housing 1602, the chute 1601, and the extrusion cap 1604. In the example, the foods are forced down the chute 1601 into the unit housing 1602, where the auger 1703 forces the food items through grinding components. The ground food items are forced though the extrusion cap 1604 into the collection bin 107.

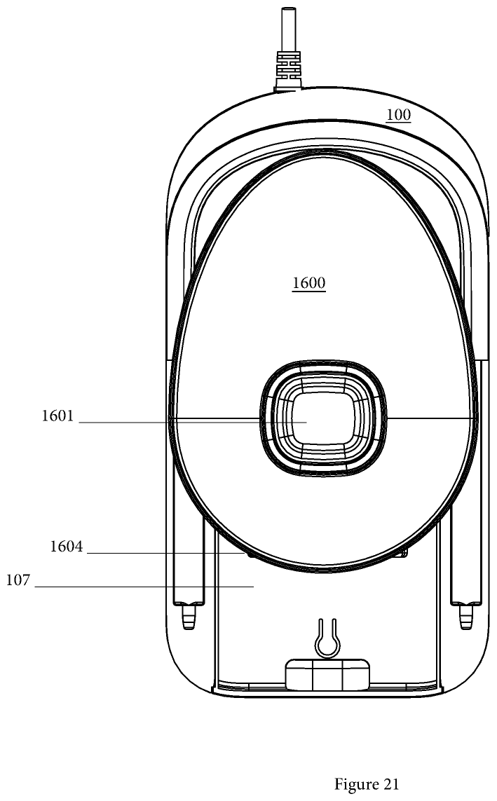

FIG. 21 is a top view of the food processing device 100 with the grinder component 1600 attached, in accordance with certain examples of the technology disclosed herein. Illustrated in FIG. 21 are the body of the device 100, the grinder component 1600, the chute 1601, and the extrusion cap 1604. In the example, the foods are forced down the chute 1601 into the unit housing 1602, where the auger 1703 forces the food items through grinding components. The ground food items are forced though the extrusion cap 1604 into the collection bin 107.

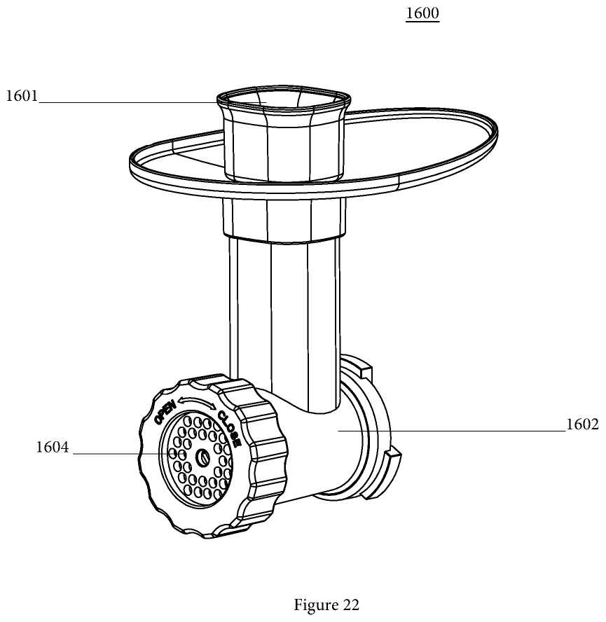

FIG. 22 is a perspective view of the grinder component 1600, in accordance with certain examples of the technology disclosed herein. Illustrated in FIG. 22 are the unit housing 1602, the chute 1601, and the extrusion cap 1604. In the example, the foods are forced down the chute 1601 into the unit housing 1602, where the auger 1703 forces the food items through grinding components. The ground food items are forced though the extrusion cap 1604.

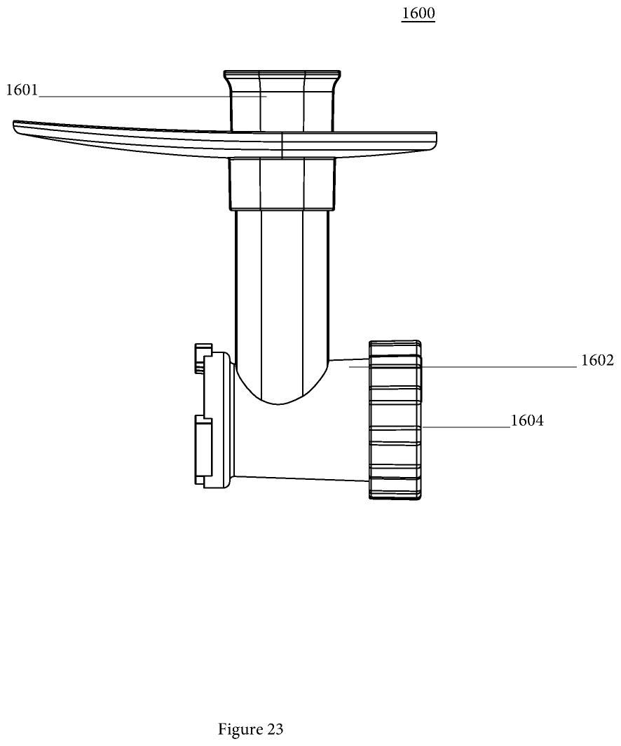

FIG. 23 is a side view of the grinder component 1600, in accordance with certain examples of the technology disclosed herein. Illustrated in FIG. 22 are the unit housing 1602, the chute 1601, and the extrusion cap 1604. In the example, the foods are forced down the chute 1601 into the unit housing 1602, where the auger 1703 forces the food items through grinding components. The ground food items are forced though the extrusion cap 1604.

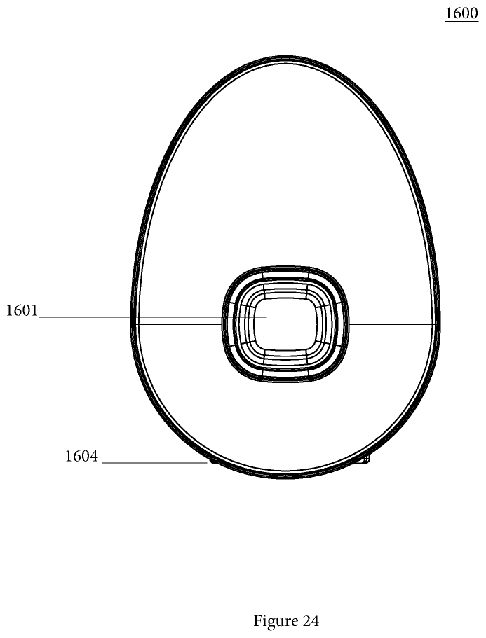

FIG. 24 is a top view of the grinder component 1600, in accordance with certain examples of the technology disclosed herein. Illustrated in FIG. 24 are the chute 160 and the extrusion cap 1604. In the example, the foods are forced down the chute 1601 into the unit housing 1602, where the auger 1703 forces the food items through grinding components. The ground food items are forced though the extrusion cap 1604.

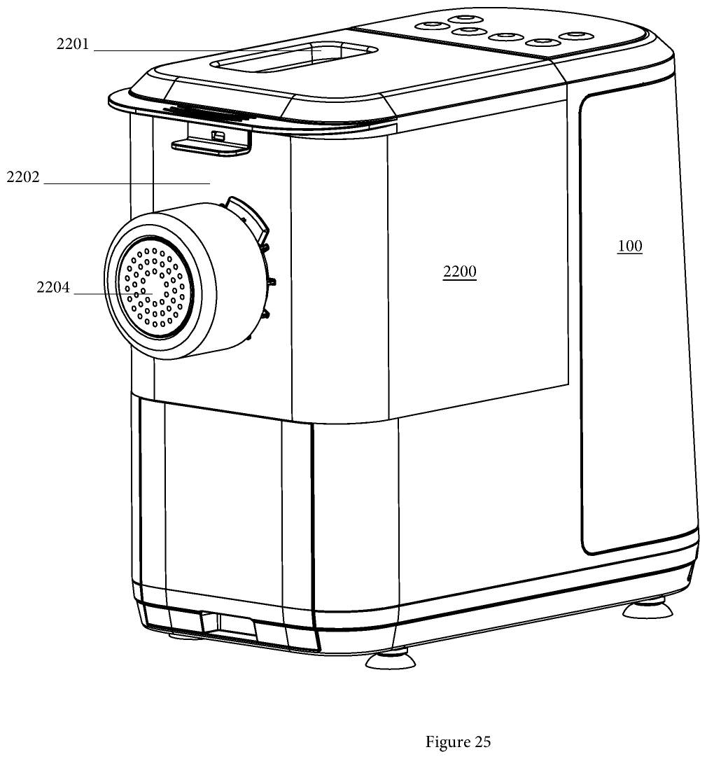

FIG. 25 is a perspective view of one embodiment of the food processing device 100 with a pasta maker component 2200 attached, in accordance with certain examples of the technology disclosed herein. As described herein, the pasta maker component 2200 is connected to the device 100 via the mounting ring 102. The pasta maker component 2200 connects to the device 100 in any suitable manner. For example, connection clips are configured to clip into the connection slots 105 of the device 100. Additionally, the pasta maker component 2200 may have grooves on the mixing chamber 2200 that mates with the fastening mechanism 106 to hold the chamber in place.

The pasta maker component 2200 is illustrated with a chute 2201 for delivering food items to the body of the pasta maker component 2200. In an example a plunger or other device is used to push food items, such as flour, water, eggs, and other ingredients of pasta, down to the mixing chamber 2202. The mixing chamber has a central drive that includes paddles for mixing and kneading the ingredients and an augur for forcing the food items towards the extrusion cap 2204.

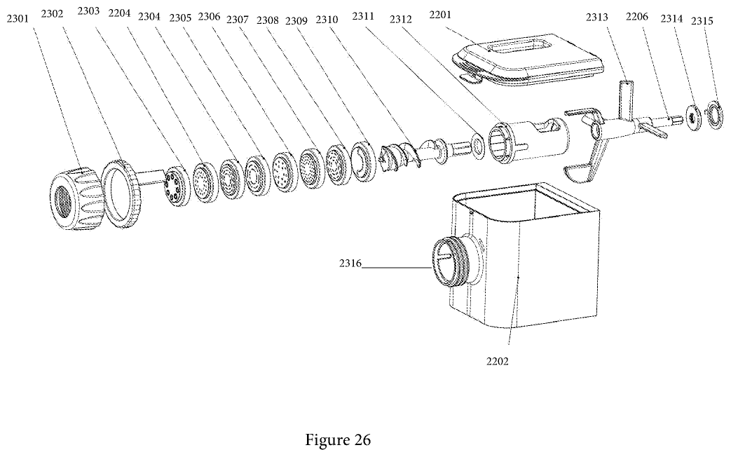

The pasta maker component 2200 is shown with a multi-hole extrusion cap 2204. Other shapes of extrusion cap 2204 may be used to make different shapes of pasta as illustrated in FIG. 26.

The extrusion cap 2204 is screwed or otherwise affixed to the body of the pasta maker component 2200, such as by a seal cap connected to the mixing chamber 2202. The mixing chamber 2202 encases the auger and other components used to extrude the pasta through the extrusion cap 2204.

In an example, the device 100, via the drive socket 101, turns the paddles and the auger in a direction that is opposite the drive direction of the auger. That is, if the auger has a helical screw that moves product forward when the auger is turned in the clockwise direction, then the device 100 will turn the auger in the counter-clockwise direction during the kneading process. Operating the auger in the counter-clockwise direction increases the residence time in the mixing chamber 2202 and prevents pasta from being forced through the extrusion cap 2204. The paddles knead and mix the ingredients for pasta until a pasta dough is formed. The device 100 will then pause the auger and begin to turn the auger in the opposite direction, such as clockwise. The pasta dough is then grabbed by the helical screw and forced towards the extrusion cap 2204. The paddles will mix and knead the pasta in the opposite direction.

The auger continues to increase the pressure of the food items until the pasta is extruded through the extrusion cap 2204. The extruded pasta is either collected by a user or falls onto a plate or other collection device.

After the pasta has all been extruded, the pasta maker component 2200 may be removed from the device 100 via any other suitable manner disengaging the pasta maker component 2200.

FIG. 26 is an exploded perspective view of internal components of the pasta maker component 2200, in accordance with certain examples of the technology disclosed herein. The mixing chamber 2202 is illustrated with the auger 2310 and other components removed. When in operation, one or more of the components in the exploded diagram are connected or encased in another component. Other components are illustrated as being interchangeable options.

The mixing chamber 2202 is illustrated with a removable lid and chute 2201. The chute allows liquids and smaller solids to be added to the mixing chamber 2202. When a larger quantity or size of food item is added to the mixing chamber 2202, the top may be removed to allow the larger food item to be added to the mixing chamber 2202.

In an example, the auger 2310 and the paddles 2313 are inside the inner chamber of the mixing chamber 2202 when in operation. The drive shaft 2206 is integral to or connected to the paddles 2313, which is in turn integral or connected to the auger 2310. The drive shaft 2206 is illustrated with a hexagonal outer perimeter for mounting into the drive shaft socket 101.

The paddles 2313 are illustrated with five paddles in various configurations. Other paddle configurations and number of paddles may be used to provide proper mixing and kneading of pastas and other food items. In the example, three paddles are rectangular in shape and disposed in various locations on the paddle 2313 assembly. Two paddles are illustrated with curved bodies to allow the paddles 2313 to properly collect and mix all food ingredients in the mixing chamber 2202. The auger sleeve 2312, the spacer 2311, the sealing ring 2314, and the ring cover 2315 are used to assist with attaching the auger 2310 to the paddles 2313 and attaching the paddles 2313 to the device 100. The auger 2310 may be connected to the paddle 2313 with a hexagonal driver and socket arrangement. The auger 2310 may have a drive shaft that mates with a drive socket on the paddle 2313 such that when the paddle 2313 turns, the auger 2310 turns.

The auger 2310 is illustrated with a helical screw on the body that when screwed in a clockwise direction, forces food items toward the tip of the auger 2310 and away from the drive shaft 2206. Any other configuration of auger 2310 may be used to force the food downstream, such as a piston type device or a baffled auger.

The seal cap 2301 and the collector ring 2302 are affixed to the mixing chamber 2202 via a screwed mechanism, a friction mechanism, latches, a bolted mechanism, or any other suitable connection mechanism. The extrusion cap 2204 is similarly affixed to the seal cap 2301. Other extrusion cap configurations may be used to create different sizes and styles of pasta. For example, extrusion cap 2303 may be used to create penne pasta, extrusion cap 2304 may be used to create linguine, extrusion cap 2305 may be used to create tagliatelle, extrusion cap 2306 may be used to create udon, extrusion cap 2307 may be used to create angel hair, extrusion cap 2308 may be used to create fettucine, and extrusion cap 2309 may be used to create lasagna.

The components illustrated may be connected into a single unit to form the pasta maker component 2200.

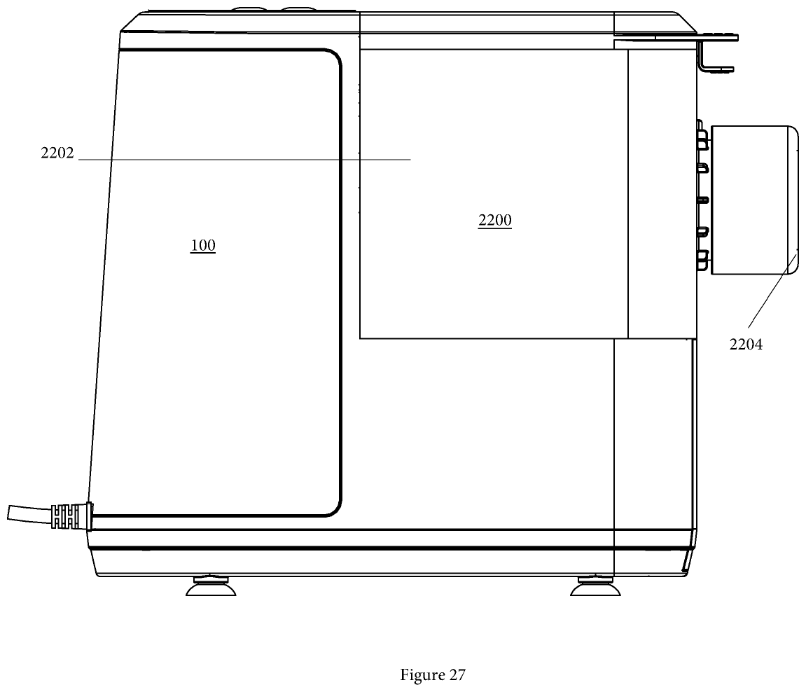

FIG. 27 is a side view of the food processing device 100 with the pasta maker component 2200 attached, in accordance with certain examples of the technology disclosed herein. Illustrated in FIG. 27 are the body of the device 100, the pasta maker component 2200, the mixing chamber 2202, and the extrusion cap 2204. In the example, the pasta ingredients are poured down the chute 2201 into the mixing chamber 2202, where the ingredients are mixed, kneaded, and augered out of the extrusion cap 2204.

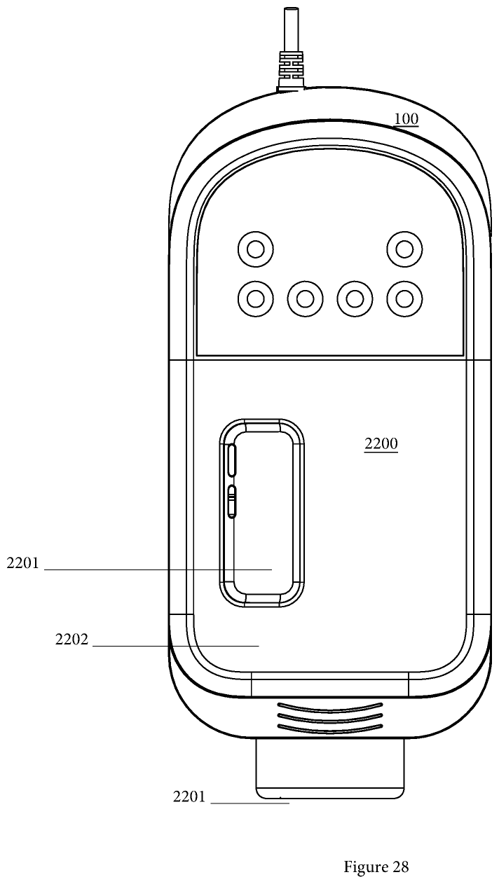

FIG. 28 is a top view of the food processing device 100 with the pasta maker component 2200 attached, in accordance with certain examples of the technology disclosed herein. Illustrated in FIG. 28 are the body of the device 100, the pasta maker component 2200, the chute 2201, the mixing chamber 2202, and the extrusion cap 2204. In the example, the pasta ingredients are poured down the chute 2201 into the mixing chamber 2202, where the ingredients are mixed, kneaded, and augered out of the extrusion cap 2204.

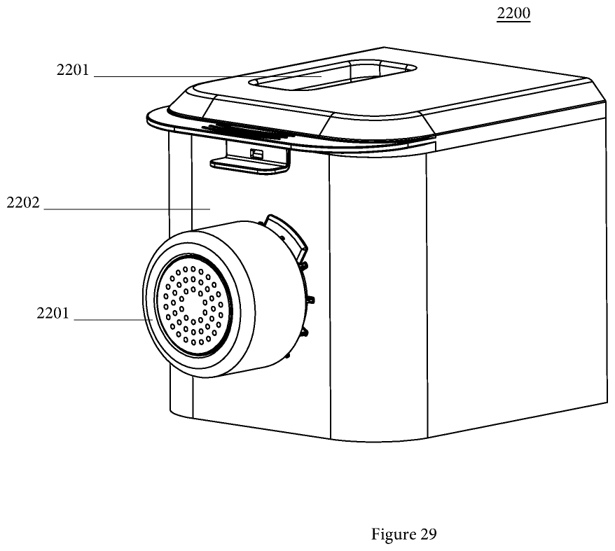

FIG. 29 is a perspective view of the pasta maker component 2200, in accordance with certain examples of the technology disclosed herein. Illustrated in FIG. 29 are the body of the pasta maker component 2200, the mixing chamber 2202, the chute 2201, and the extrusion cap 2204. In the example, the pasta ingredients are poured down the chute 2201 into the mixing chamber 2202, where the ingredients are mixed, kneaded, and augered out of the extrusion cap 2204.

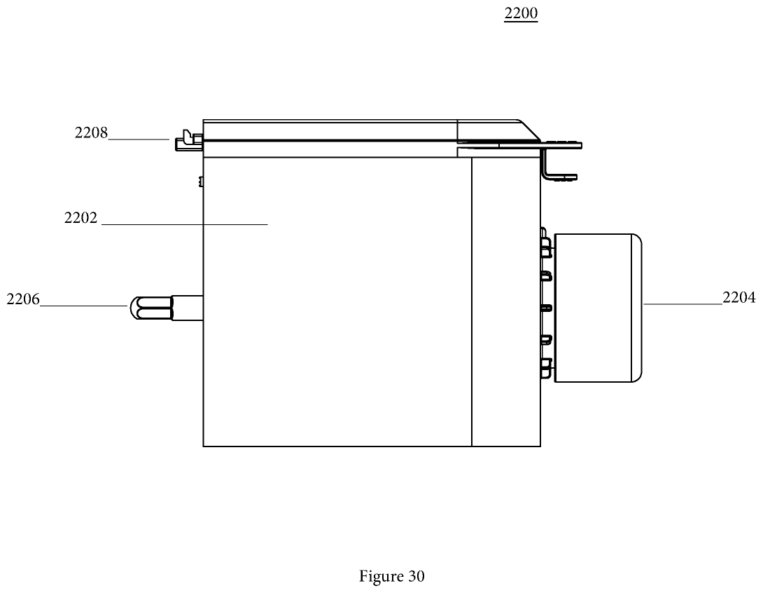

FIG. 30 is a side view of the pasta maker component 2200, in accordance with certain examples of the technology disclosed herein. Illustrated in FIG. 30 are the body of the pasta maker component 2200, the mixing chamber 2202, the connection clip 2208, the drive shaft 2206, and the extrusion cap 2204. The drive shaft 2206 is connected to the paddle 2313, and which is connected to the auger 2310, inserted into the drive shaft socket 101 of the device 100, and forces the auger 2310 and the paddle 2313 to turn when the drive shaft socket 101 turns. The connection clip 2208 mates with the connection slot 101 in the device 100 and locks the pasta maker component 2200 to the device 100. In the example, the pasta ingredients are poured down the chute 2201 into the mixing chamber 2202, where the ingredients are mixed, kneaded, and augered out of the extrusion cap 2204.

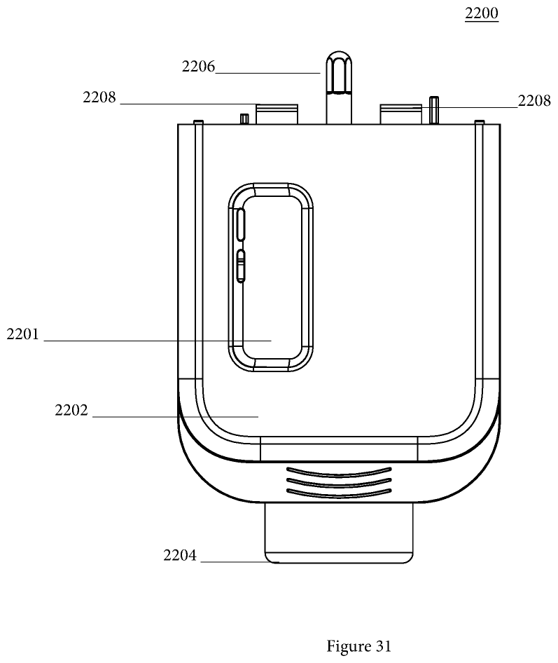

FIG. 31 is a top view of the pasta maker component 2200, in accordance with certain examples of the technology disclosed herein. Illustrated in FIG. 31 are the body of the pasta maker component 2200, the chute 2201, the mixing chamber 2202, the connection clips 2208, the drive shaft 2206, and the extrusion cap 2204. The drive shaft 2206 is connected to the paddle 2313, which is connected to the auger 2310, inserts into the drive shaft socket 101 of the device 100, and forces the auger 1103 and the paddle 2313 to turn when the drive shaft socket 101 turns. The connection clips 2208 mate with the connection slot 101 in the device 100 and lock the pasta maker component 2200 to the device 100. In the example, the pasta ingredients are poured down the chute 2201 into the mixing chamber 2202, where the ingredients are mixed, kneaded, and augered out of the extrusion cap 2204.

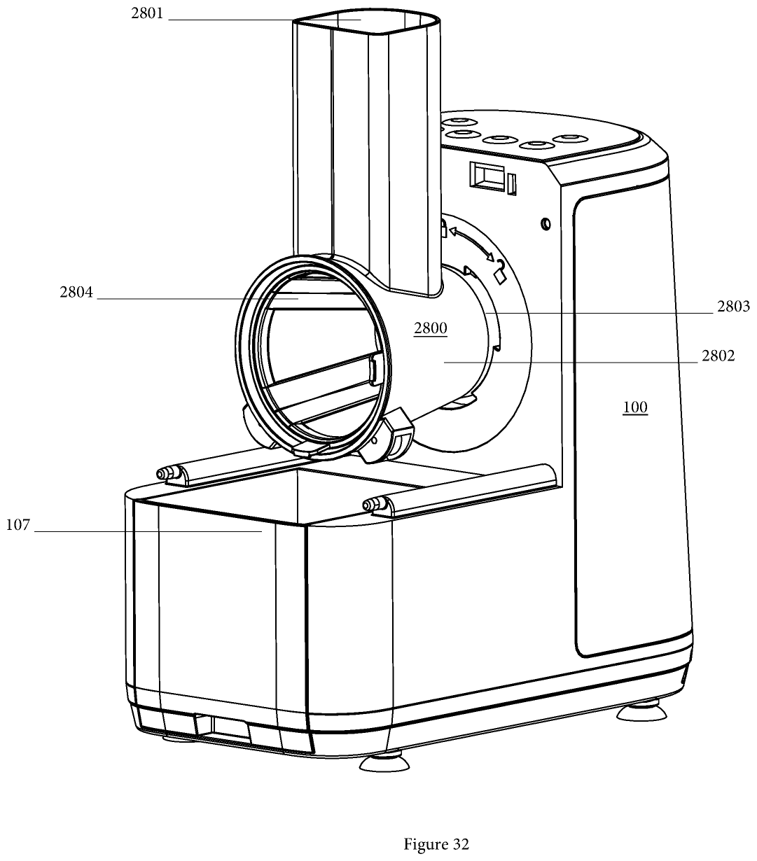

FIG. 32 is a perspective view of one embodiment of the food processing device 100 with a slicer component 2800 attached, in accordance with certain examples of the technology disclosed herein. As described herein, the slicer component 2800 is connected to the device 100 via the mounting ring 102. A mated screwed connection 2803 of the slicer component 2800 is screwed or otherwise connected into the mounting ring 102. In the example, the mated screwed connection 2803 is inserted into the opening of the mounting ring 102 and rotated counter-clockwise to lock the slicer component 2800 onto the device 100. The connection may be a screwed connection, a friction connection, a bolt-on connection, a latched connection, or any other suitable connection.

The slicer component 2800 is illustrated with a chute 2801 for delivering food items to the body of the slicer component 2800. In an example a plunger or other device is used to push food items, such as meats, cheeses, vegetables, or other suitable frozen foods, down to the slicer blades 2804. The unit housing 2802 encases the slicer blades 2804 and other components used to slice food items.

In an example, the drive shaft connected to the slicer blades 2804 forces the slicer blades 2804 to spin. The food item is forced into the chute 2801 by a plunger or other device. The slicer blades 2804 contact the food item when the spinning slicer blades 2804 pass the opening to the chute 2801 where the chute 2801 connects to the unit housing 2802. The outside perimeter of the slicer blades 2804 is located within the body of the unit housing 2802 and has blades, grooves, grates, sharpened baffles, or other mechanical means of slicing off pieces of the food products that are in the chute 2801. In an example, the food item is forced against the spinning slicer blades 2804 by a plunger in the chute 2801. When parts of the food item are sliced off by the slicer blades 2804, the sliced portion passes into the interior of the slicer blade 2804 assembly. The sliced portions fall into the collection bin 107 via the open end of the slicer blade 2804 assembly and the open unit housing 2802.

After the food item has all been sliced, the slicer component 2800 may be removed from the device 100 by pushing the release button 103, unscrewing the mated screwed connection 2803 from the mounting ring 102, or in any other suitable manner disengaging the slicer component 2800.

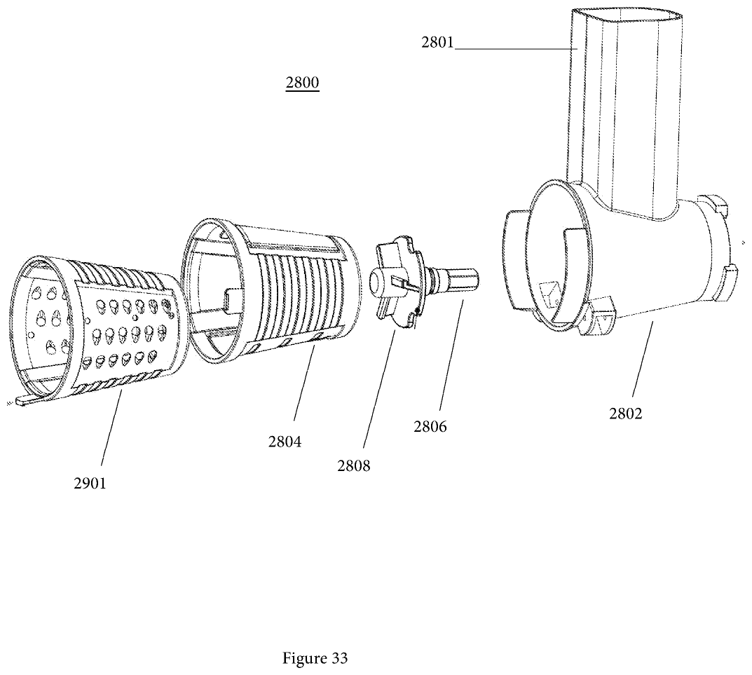

FIG. 33 is an exploded perspective view of internal components of the slicer component 2800, in accordance with certain examples of the technology disclosed herein. The unit housing 2802 is illustrated with the slicer blades 2804 and other components removed. When in operation, one or more of the components in the exploded diagram are connected or encased in another component. For example, the slicer blades 2804 are inside the inner chamber of the unit housing 2802 when in operation. The drive shaft 2806 is integral to or connected to the slicer blades 2804. The drive shaft 2806 is illustrated with a hexagonal outer perimeter for mounting into the drive shaft socket 101 and an engagement sprocket 2808 for engaging the slicer blades 2804. The engagement sprocket 2808 may be of any size or shape that allows the spinning drive shaft 2806 to cause the slicer blades 2804 to turn inside the unit housing 2802.

The slicer blades 2804 may have any type of slicing mechanism. For example, slicer blades 2804 is illustrated with two longitudinal slicer blades that run the length of the slicer blades 2804 assembly. Alternatively, optional slicer blades 2901 is illustrated with a grater configuration of blades to grate food products. Any other suitable configuration of blades may be used to slice the food products into different size and shapes of slices.

All of the components illustrated may be connected into a single unit to form the slicer component 2800.

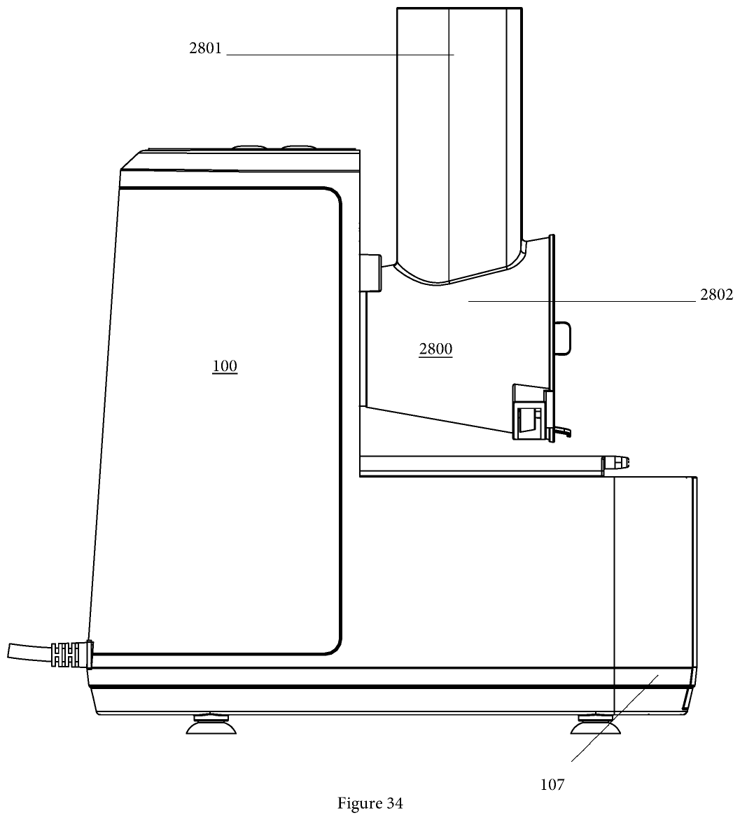

FIG. 34 is a side view of the food processing device 100 with the slicer component 2800 attached, in accordance with certain examples of the technology disclosed herein. Illustrated in FIG. 34 are the body of the device 100, the slicer component 2800, the unit housing 2802, the chute 2801, and the collection bin 107. In the example, the foods are forced down the chute 2801 into the unit housing 2802, where the slicer blades 2804 slice off portions of the foods. The sliced food items fall out of the unit housing 2802 and into the collection bin 107.

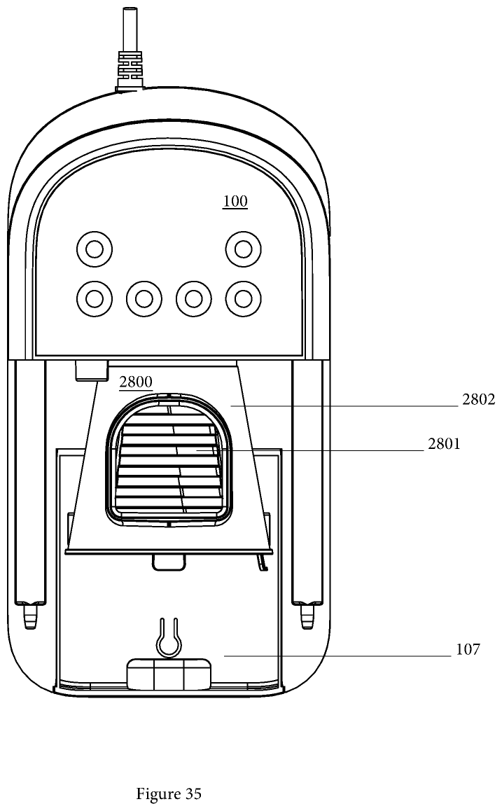

FIG. 35 is a top view of the food processing device 100 with the slicer component 2800 attached, in accordance with certain examples of the technology disclosed herein. Illustrated in FIG. 35 are the body of the device 100, the slicer component 2800, the unit housing 2802, the chute 2801, and the collection bin 107. In the example, the foods are forced down the chute 2801 into the unit housing 2802, where the slicer blades 2804 slice off portions of the foods. The sliced food items fall out of the unit housing 2802 and into the collection bin 107.

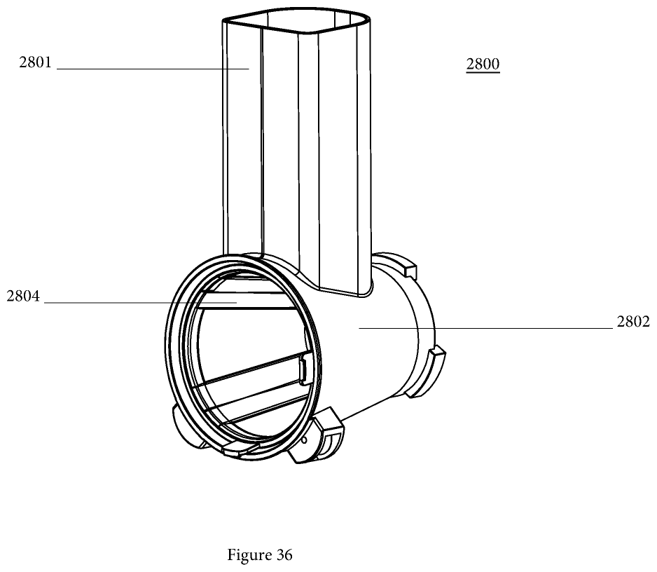

FIG. 36 is a perspective view of the slicer component 2800, in accordance with certain examples of the technology disclosed herein. Illustrated in FIG. 36 are the slicer component 2800, the unit housing 2802, the chute 2801, and the slicer blades 2804. In the example, the foods are forced down the chute 2801 into the unit housing 2802, where the slicer blades 2804 slice off portions of the foods. The sliced food items fall out of the unit housing 2802 and into the collection bin 107.

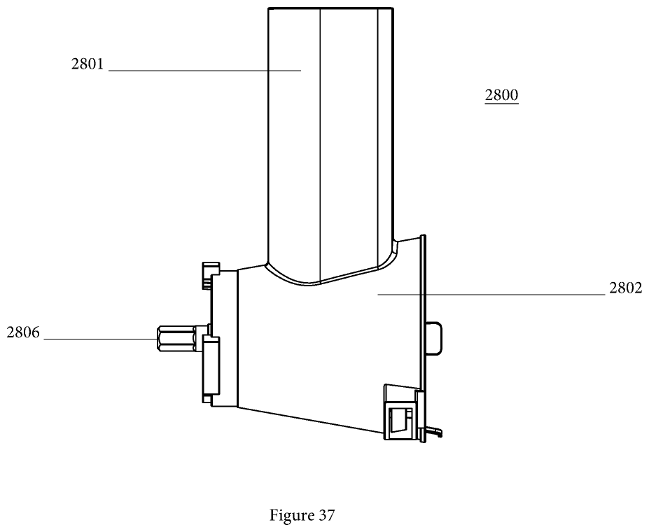

FIG. 37 is a side view of the slicer component 2800, in accordance with certain examples of the technology disclosed herein. Illustrated in FIG. 37 are the slicer component 2800, the unit housing 2802, the chute 2801, and the drive shaft 2806. In the example, the foods are forced down the chute 2801 into the unit housing 2802, where the slicer blades 2804 slice off portions of the foods. The sliced food items fall out of the unit housing 2802 and into the collection bin 107. The spinning drive shaft 2806 causes the slicer blades 2804 to turn inside the unit housing 2802.

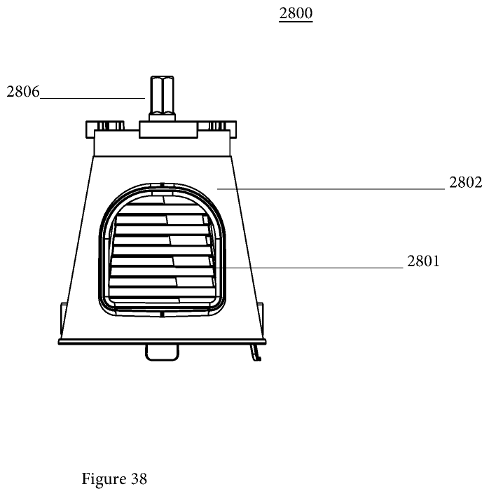

FIG. 38 is a top view of the slicer component 2800, in accordance with certain examples of the technology disclosed herein. Illustrated in FIG. 38 are the slicer component 2800, the unit housing 2802, the chute 2801, and the drive shaft 2806. In the example, the foods are forced down the chute 2801 into the unit housing 2802, where the slicer blades 2804 slice off portions of the foods. The sliced food items fall out of the unit housing 2802 and into the collection bin 107. The spinning drive shaft 2806 causes the slicer blades 2804 to turn inside the unit housing 2802.

In examples, a user may attach any of the components as described herein to change the function of the device 100. For example, a user may attach the juicer component 1000 as described herein, juice some fruit, remove the juicer component 1000, attach the slicer component 2800, slice some meat product, and remove the slicer component 2800. Each of the components described herein may be attached and detached as often as desired to prepare foods.

1-20. (canceled)

21. A multi-function food processing apparatus and accessory kit, comprising:
a base unit comprising a housing having a first housing portion for sitting on a surface during use and a second housing portion within which an electric motor is operatively supported, the electric motor being supported so that a drive shaft of the electric motor extends along an axis of rotation at least toward an access opening of the second housing portion with a coupling feature provided at the end of the drive shaft and accessible by way of the access opening, the second housing portion also including an accessory mounting feature at least partially surrounding the access opening;
a plurality of food processing interchangeable accessories, each food processing interchangeable accessory comprising an accessory housing including a complimentary feature to the accessory mounting feature of the upper housing portion for removable and interchangeable connection of the food processing interchangeable accessory with the base unit and a food delivery access to allow food delivery into the interior of the accessory housing, each food processing interchangeable accessory also including a rotatable element operatively supported within the accessory housing that extends in the axial direction of the drive shaft, the rotatable component having a complimentary shaft connection feature extending from the rotatable component for rotatable connection with the coupling feature of the drive shaft that when the rotatable component is rotated as driven by the drive shaft, such rotation tends to move food along the rotatable component toward an end of the accessory housing, the end of the accessory housing including at least one opening from which food product can be dispensed.

22. The food processing apparatus and accessory kit of claim 1, wherein the rotatable component of the plurality of food processing interchangeable accessories comprises an auger with a helical thread for moving food product toward the opening at the end of the accessory housing when the auger is rotated in a first rotational direction by the electric motor and the drive shaft.

23. The food processing apparatus and accessory kit of claim 22, wherein the electric motor is reversible so that the auger can be driven in a second rotational direction during which food product would not move toward the opening of the accessory housing.

24. The food processing apparatus and accessory kit of claim 23, wherein the food processing interchangeable accessory comprises a pasta maker and the auger is rotatably also connected with at least one paddle for mixing pasta ingredients in the accessory housing without moving the pasta ingredients toward the opening of the accessory housing.

25. The food processing apparatus and accessory kit of claim 22, further comprising an extrusion cap provided at the opening at the end of the accessory housing, the extrusion cap being interchangeable with other extrusion caps of the accessory kit for changing at least one of the shape, size, and number of openings from which food product can be extruded.

26. The food processing apparatus and accessory kit of claim 25, wherein the plural food processing interchangeable accessories includes any number of the following types of food processing interchangeable accessories: a juicer, a frozen desert maker, a grinder, and pasta maker.

27. The food processing apparatus and accessory kit of claim 21, further including a slicer accessory as another food processing interchangeable accessory in addition to the plural food processing interchangeable accessories that includes a rotatable blade assembly with the complimentary shaft connection feature thereof rotatably connected with the drive shaft for slicing food directed into the slicer assembly at the food delivery access.

28. The food processing apparatus and accessory kit of claim 21, wherein the food delivery access comprises a chute connected with the accessory housing.

29. The food processing apparatus and accessory kit of claim 21, wherein a control panel on the base unit controls each of the one or more food processing interchangeable accessories.

30. The food processing apparatus and accessory kit of claim 29, further including a batch button on the control panel that initiates an automatic process to operate one of the one or more food processing interchangeable accessories.

31. The food processing apparatus and accessory kit of claim 24, wherein a batch button is provided as part of a control panel on the base unit and controls a pasta making process when the pasta making food processing interchangeable accessory is mounted with the base unit so that the auger thereof is rotated in the second rotational direction during mixing pasta ingredients followed by rotating the auger in the first rotational direction for extruding pasta.
